(19) United States
(12) Patent Application Publication
(10) Pub. No.: US 2003/0172759 A1
(43) Pub. Date: Sep. 18, 2003

(54) Ball screw

(75) Inventor: Eiji Hayashi, Kanagawa (JP)

Correspondence Address: SUGHRUE MION, PLLC, 2100 PENNSYLVANIA AVENUE, N.W., WASHINGTON, DC, 20037, US

(73) Assignee: NSK LTD.

(21) Appl. No.: 10/370,723

(22) Filed: Feb. 24, 2003

(30) Foreign Application Priority Data
Feb. 25, 2002 (JP) P.2002-048077
Jun. 19, 2002 (JP) P.2002-178467
Sep. 12, 2002 (JP) P.2002-267104
Aug. 30, 2002 (JP) P.2002-255067

(51) Int. Cl. F16H 55/02; F16H 1/24

(52) U.S. Cl. 74/424.86; 74/424.87

(57) ABSTRACT

A ball screw has a screw shaft including a ball thread groove formed on an outer peripheral surface thereof, a nut including a ball thread groove formed on an inner peripheral surface thereof, the inner peripheral surface being opposed to the outer peripheral surface of the screw shaft, and a side cap mount surface being formed in the outer peripheral surface of the nut, a plurality of balls disposed between the thread groove of the nut and the thread groove of the screw shaft; and, a side cap fastened to the side cap mount surface and including a ball scooping part and a ball return path for scooping up the balls from one side and returning the balls to another side.

### BACKGROUND OF THE INVENTION

1. Field of the Invention

The present invention relates to a ball screw used in industrial machinery and in a machine tool as a mechanical component, such as a motor, which converts rotary motion into linear motion.

2. Description of the Related Art

Ball screws used in machine tools are classified as ball screws using an end cap as a component for circulating balls and ball screws using a ball circulation tube. Of these ball screws, a ball screw using an end cap can circulate balls while suppressing occurrence of vibration and noise. However, the number of ball circulation circuits is limited to the number of thread grooves. Hence, if the number of balls per circuit (i.e., the number of windings per circuit) is increased in order to increase load capacity, there will arise a problem of a drop in operability of the ball screw.

A ball screw using a ball circulation tube has an advantage of the ability to form a plurality of ball circulation circuits for a single ball screw thread. However, the ball screw has a construction such that balls rolling between the ball thread groove of a screw shaft and that of a nut are caused to collide with a tongue part of the ball circulation tube, thereby scooping up the balls into the ball circulation tube. Hence, noise and vibration develop, and fatigue cracks or the like develop in the tongue part.

To solve these problems, several ball screws have been conceived. One ball screw has a construction such that a hole for scooping balls up and a hole for returning balls are drilled in a nut in a tangential direction while being inclined in agreement with lead angles of ball thread grooves (see JP-UM-A-59-39352). Another ball screw has a construction such that two holes, each being larger than an outer diameter of the ball circulation tube, are drilled and such that the ball circulation tube is inserted into the nut by way of the holes at right angles to the surface of the nut (see JP-A-2000-18359). Still another ball screw has a construction such that a pair of tube pieces are provided at respective ends of the ball circulation tube and such that a guide hole having a guide area for guiding balls in a tangential direction along the lead angle of the ball thread groove is provided in each of the tube pieces (see JP-A-11-51049).

However, the ball screws described in Patent Publications 1 through 3 yield the following problems. Specifically, in the ball screw described in JP-UM-A-59-39352, a hole for scooping balls up (also called a “ball scooping hole”) and a ball return hole must be formed in a nut while remaining inclined to the lead angles of the ball thread grooves. Efforts are required to machine the ball scooping hole and the ball return hole, thereby incurring a cost rise. In the ball screw described in JP-UM-A-59-39352, a tube is divided into two segments at any point along a path extending from the ball scooping hall to the ball return hole in a longitudinal direction of the tube. The two thus-split pieces are joined together, thereby constituting the ball circulation tube. Hence, a step arises in the joint between the two pieces of the tube. A problem arises in that vibration or noise develops as a result of balls colliding with the step.

The ball screw described in JP-A-2000-18359 presents a problem of large clearance arising between the nut and the ball circulation tube. A lubricant may leak from the clearance, or extraneous matter, such as dust, may enter the nut. In the case of the ball screw described in JP-A-11-51049, components for scooping balls up (i.e., tube pieces) and the circulation tube are separate from each other. Hence, a step arises in areas where the components and the tube are joined together. Noise or vibration may develop as a result of balls colliding with the step.

In the ball screw of circulation tube type, a single thread groove can be provided with a plurality of ball circulation circuits. However, the direction in which balls are to be scooped up is at right angles to the axial direction of the screw shaft. Hence, if the thread grooves have a large lead, the traveling direction of balls is abruptly changed at the ball circulation part. Consequently, there may arise problems, such as infliction of damage on an interior surface of the tube or occurrence of vibration, which would be caused when balls collide with the interior surface of the tube during the course of being scooped up.

The ball screw of end cap type scoops balls up by means of the end caps provided at both ends of the nut. Hence, damage to balls, which would be inflicted when balls are scooped up, may be less likely to arise than in the case of the ball screw of circulation tube type. However, the number of ball circulation circuits is limited to the number of thread grooves. Hence, if the number of balls per circuit (i.e., the number of coils per circuit) is increased for increasing load capacity, there will arise a problem, such as drop in operability of the ball screw.

In order to solve these problems, the present inventor has proposed a ball screw of side cap type described in Japanese Patent Application No.2002-48077.

As shown in FIGS. 80 and 81, in a ball screw 101, a screw shaft 103, which has a helical thread groove 102 formed in its outer peripheral surface, extends axially. A nut 105, which has a helical thread groove 104 corresponding to the thread groove 102 formed in its interior peripheral surface, is fitted to the screw shaft 103. The thread groove 104 of the nut 105 and the thread groove 102 of the screw shaft 103 oppose each other, thereby defining a helical loaded rolling groove therebetween. A plurality of balls 106 acting as rolling elements are loaded into the loaded rolling groove in a rotatable manner. Through rotation of the screw shaft 103 (or the nut 105), the nut 105 (or the screw shaft 103) is moved axially by means of rolling actions of the balls 106.

A flat surface is formed in the outer peripheral surface of the nut 105 and taken as a mount surface 108. A cap main body 107a of a side cap 107 is fixed to the mount surface 108 by fixing means; e.g., a screw. A pair of columnar or block-shaped parts 109 for scooping balls up (hereinafter called “ball scooping parts 109”) are formed in a lower surface of the cap main body 107a. The ball scooping parts 109 are spaced apart from each other in the axial direction of the screw shaft 103 as well as in the radial direction of the same. The ball scooping parts 109 are inserted into a pair of holes 110 which are drilled in the mount surface 108 so as to make communication with the loaded rolling groove defined between the thread grooves 102, 104. The cap main body 107a is fixed to the mount surface 108, by means of fixing means such as screws, with the ball scooping parts 109 being inserted into the holes 110.

A path 111 for scooping balls up (hereinafter called a “ball scooping path”) is formed in each of the ball scooping parts 109 so as to extend in a direction matching the lead angles of the thread grooves 102, 104. A ball path 112 is formed in the cap main body 107a for interconnecting the ball scooping paths 111. The ball scooping paths 111 and the ball path 112 constitute, in the side cap 107a, a ball circulation path 120. The ball circulation path 120 scoops up the balls 106, which roll at a point located in the vicinity of one axial end (or the other axial end) on the loaded rolling groove defined between the thread grooves 102, 104, in the direction matching the lead angles of the thread grooves 102, 104, and returns the balls 106 to a point located in the vicinity of the other axial end (or one axial end) on the loaded rolling groove.

In contrast with the case of the ball screw of circulation tube type, the traveling direction of balls does not change abruptly at the ball circulation parts even when the lead of the thread grooves becomes large. Therefore, infliction of damage to the interior surface of the tube, which would otherwise be caused when balls collide with the interior surface during the course of being scooped up, can be prevented. Moreover, in contrast with the case of the ball screw of end cap type, the number of ball circulation circuits is not limited to the number of thread grooves. Hence, load capacity can be increased without involvement of an increase in the number of balls per circuit (i.e., the number of coils per circuit).

However, in the ball screw of side cap type having the foregoing construction, noise developing in the nut escapes to the outside by propagating through the side caps. In particular, when side caps are split along a ball circulation path for facilitating constitution of the ball circulation path in the side caps and the thus-split cap members are subsequently joined, there arises a problem of noise leaking from the inside of the nut by way of clearance existing in the joint.

### SUMMARY OF THE INVENTION

The present invention has been conceived in light of the problems and is aimed at providing a ball screw capable of preventing occurrence of damage to balls or noise, which would otherwise be caused when balls are scooped up, as well as of increasing load capacity without involvement of an increase in the number of balls per circuit (i.e., the number of windings per circuit).

The present invention has been conceived to solve the problems and is aimed at providing a ball screw which can reduce noise escaping to the outside from the inside of a nut and which can naturally prevent infliction of damage to balls, which would otherwise be caused during the course of the balls being scooped up, and increase load capacity without involvement of an increase in the number of balls per circuit (the number of coils per circuit).

To achieve the object, the present invention according to a first aspect presents a ball screw having a screw shaft including a ball thread groove formed on an outer peripheral surface thereof, a nut including a ball thread groove formed on an inner peripheral surface thereof, the inner peripheral surface being opposed to the outer peripheral surface of the screw shaft, and a side cap mount surface being formed in the outer peripheral surface of the nut, a plurality of balls disposed between the thread groove of the nut and the thread groove of the screw shaft and, a side cap fastened to the side cap mount surface and including a ball scooping part and a ball return path for scooping up the balls from one side and returning the balls to another side.

By means of such a configuration, the balls rolling between the ball thread groove of the screw shaft and that of the nut are scooped up in a direction matching the lead angles of the ball thread grooves and are returned to the initial position. Accordingly, unlike the case of a ball screw of tube circulation type, the traveling direction of the balls does not change abruptly at a ball circulation part even when leads of the ball thread grooves become large. Hence, infliction of damage to balls or occurrence of noise, which would otherwise be caused when balls are scooped up, can be prevented. Unlike the case of a ball screw of end cap type, the number of ball circulation circuits is not limited to the number of thread grooves. Hence, load capacity can be increased without involvement of an increase in the number of balls per circuit.

In this case, as in the case of the present invention defined in a second aspect, the ball return path formed in an inside of the side cap is divided into a plurality of pieces along a direction of movement of the balls. By means of such a construction, the ball return path for scooping up the balls in a direction matching the lead angles of the ball thread grooves and returning the balls to the initial position can be readily formed in the side cap.

As in the case of the present invention defined in a third aspect, the side cap may be formed by combining side-cap-constituting members having identical shapes each other symmetrically about a point. By means of such a construction, the side cap can be formed through use of a single mold. Hence, the side cap can be manufactured inexpensively. If, as in the case of the present invention defined in a fourth aspect, the side cap is formed from resin, the side cap can be mass-produced inexpensively by means of injection molding. Moreover, if, as in the case of the present invention defined in a fifth aspect, the side cap is formed from sintered material, rotational balance in a nut can be achieved when the ball screw is constructed as a rotational type. Further, the ball screw can be used under high temperature conditions that are unsuitable for resin.

As in the case of the present invention defined in a sixth aspect, a cushioning member may be interposed between a ball circulation hole formed in the nut and the ball scooping part inserted into the ball circulation hole. By adoption of such a construction, the collision force exerted on the side cap by the balls is not transmitted directly to the nut as excitation force. Therefore, occurrence of noise or vibration, which would otherwise be caused when the balls exert the collision force on the side cap, can be prevented.

As in the case of the present invention defined in a seventh aspect, an elastic member may be interposed between the side cap mount surface and the side cap. By adoption of such a construction, when the balls are clogged in the ball return path in the side cap, the length of the ball return path is extended by the pushing force developing among the balls, thereby improving the operability of the ball screw. Further, infliction of damage to the balls, which would otherwise be caused by collision between the balls, can be prevented.

As in the case of the present invention defined in a eighth aspect, the side cap may be pressed against the side cap mount surface by an elastic pressing member provided on the outer periphery of the nut. Adoption of such a construction eliminates the necessity for forming, in the nut, mount holes required to fasten the side cap to the nut with screws. Consequently, costs incurred in machining the mount holes can be curtailed. Further, the pressing force exerted on the side cap by the balls can be released, and hence collision force developing among the balls is diminished, thereby improving the operability of the ball screw and preventing infliction of damage to the balls.

As in the case of the present invention defined in a ninth aspect, the elastic pressing member may be at least partially housed in a groove part formed on an outer peripheral surface of at least one of the nut and the side cap. Adoption of such a construction eliminates a worry about axial displacement of the elastic pressing member, which may in turn cause dislodgment of the side cap. Moreover, as in the case of the present invention defined in a tenth aspect, the ball return path comprises a linear part provided in a center of the side cap and in parallel with the screw shaft, and curved parts extending continuously from respective ends of the linear part. By means of such a configuration, the position where the balls are to be upwardly scooped can be set close to the side cap. The number of active coils of the ball thread grooves to be formed in the inner peripheral surface of the nut becomes close to an integer. Hence, the load capacity of the ball screw can be increased.

As in the case of the present invention defined in a eleventh aspect, the ball scooping part scoops up the balls rolling between the ball thread grooves in a direction of lead angles of the ball thread grooves, to thereby guide the balls to the ball return path. By means of such a construction, collision of the balls against the ball scooping parts can be mitigated, thereby preventing occurrence of noise or vibration. As in the case of the present invention defined in a twelfth aspect, the ball scooping part scoops up the balls rolling between the ball thread grooves in a direction of tangent to a center of centroid circle of the balls, to thereby guide the balls to the ball return path. By means of such a construction, collision of the balls against the ball scooping parts can be mitigated, thereby preventing occurrence of noise or vibration. As in the case of the present invention defined in a thirteenth aspect, the ball scooping part may be located at a phase angle smaller than 90°. By means of such a construction, the number of active coils is increased and becomes close to an integer. Consequently, the load capacity of the ball screw can be increased, thereby diminishing axial unbalance in rigidity.

As in the case of the present invention defined in a fourteenth aspect, a pair of side-cap-constituting parts constituting the side cap respectively includes a groove part, the ball return path is formed by coupling the groove parts with each other, and a boundary between the surfaces of the side-cap-constituting members to be coupled is chamfered, tilted or curved so as to prevent forming a step. By adoption of such a construction, collision of balls against a step, which would arise in a boundary between mating surfaces when the ball return path is formed by combination of a pair of side-cap-constituting members, can be prevented. Further, as in the case of the present invention defined in a fifteenth aspect, the surfaces of the side-cap-constituting members to be coupled each other are curved so as to prevent forming a step in the ball return path.

In view of the ball screw defined in the first aspect, an invention defined in a sixteenth aspect is that the side cap has a pair of columnar ball scooping parts to be fitted into ball circulation holes formed in the side cap mount surface; a plate side cap main body having a ball return path connected with a ball return guide path formed in the columnar balls cooping part; and the columnar ball scooping part is formed a circular form in a cross part.

In view of the ball screw defined in the sixteenth aspect, an invention defined in the seventeenth aspect is that the ball return guide path has an inner diameter of about 1.01 to 1.3 times with respect to a diameter of the ball, and is formed in the ball scooping part in such a manner that a centerline of the ball return guide path is inclined toward a direction of tangent to a center of centroid circle of the balls rolling between the ball thread grooves.

In view of the ball screw defined in the seventeenth aspect, an invention defined in a eighteenth aspect is that the ball return guide path is formed in the ball scooping part in such a manner that the center line of the ball return guide path is located within the centroid circle of the balls at a boundary between the ball return guide path and a ball loaded rolling groove formed between the ball thread grooves.

An invention defined in a nineteenth aspect provides a ball screw has a screw shaft including a ball thread groove formed on an outer peripheral surface thereof, a nut including a ball thread groove formed on an inner peripheral surface thereof, the ball thread groove being opposed to the outer peripheral surface of the screw shaft, a plurality of balls rolling a ball loaded rolling groove disposed between the thread groove of the screw shaft and the thread groove of the nut consequently with a rolling movement of the screw shaft or the nut and a ball circulation member for circulating the balls at an outside of the nut, including two ball scooping parts fitted into a ball scooping hole and a ball return hole, respectively, both holes being opened in the outer periphery of the nut, one ball scooping part and the other ball scooping part being linked together, wherein a center axis line of the ball return path formed in the each two ball scooping parts is free from in parallel with peripheral surfaces of the ball scooping parts.

In view of the ball screw defined in the nineteenth aspect, an invention defined in a twentieth aspect is that the ball return path may be divided by two circulation-part-constituting members constituting the ball circulation member, along a direction of the ball rolling.

In view of the ball screw defined in the twentieth aspect, an invention defined in a twenty-first aspect is that the circulation-part-constituting members each have mating surfaces, and groove parts forming the ball return path are formed in the respective mating surfaces.

In view of the ball screw defined in the twentieth or twenty-first aspect, an invention defined in a twenty-second aspect is that the circulation-part-constituting members may be formed from resin by injection molding.

In view of the ball screw defined in the twentieth or twenty-first aspect, an invention defined in a twenty-third aspect is that the circulation-part-constituting members may be formed from metal by injection molding or sintering.

In view of the ball screw defined in any one of the first to twenty-third aspects, an invention defined in a twenty-fourth aspect is that a direction in which the balls may be scooped up by the ball scooping parts forms an angular difference of 15° or less with respect to a helical direction of the ball thread grooves.

In view of the ball screw defined in the nineteenth aspect, an invention defined in a twenty-fifth aspect is that the ball circulation member is formed from a tubular member, and the ball scooping parts is formed by buildup welding of both ends of the tubular member.

An invention defined in a twenty-sixth aspect provides a ball screw having a screw shaft including a helical thread groove formed on an outer peripheral surface thereof, a nut including a thread groove formed on an inner peripheral surface thereof and corresponding to the thread groove of the screw shaft and fitted to the screw shaft, a plurality of balls rotatably loaded into a loaded rolling groove defined between the thread grooves, a side cap attached to an outer peripheral part of a nut and having a ball circulation path for scooping up the balls rolling along the loaded rolling groove in a direction matching lead angles of the thread grooves and returning the balls to the loaded rolling groove and a sound insulation member provided so as to cover the side cap.

An invention defined in a twenty-seventh aspect is that a sound absorbing member is interposed between the side cap and the sound insulation member.

An invention defined in a twenty-eighth aspect provides a ball screw having a screw shaft including a helical thread groove formed on an outer peripheral surface thereof, a nut including a thread groove formed on an inner peripheral surface thereof and corresponding to the thread groove of the screw shaft and fitted to the screw shaft, a plurality of balls rotatably loaded into a loaded rolling groove defined between the thread grooves, a side cap attached to an outer peripheral part of a nut and having a ball circulation path for scooping up the balls rolling along the loaded rolling groove in a direction matching lead angles of the thread grooves and returning the balls to the loaded rolling groove and a sound insulation member provided in the side cap by insert molding.

By means of the individual constructions of the twenty-sixth to twenty-eighth aspects, balls which roll along the loaded rolling groove defined between the thread grooves are scooped up in a direction matching the lead angles of the thread grooves by means of the ball circulation path of the side cap. The balls are then returned to the loaded rolling groove. Hence, unlike the case of the ball screw of circulation tube type, even when the leads of the ball thread grooves have become large, the traveling direction of the balls does not change abruptly at the ball circulation part. Hence, infliction of damage to the balls or occurrence of vibration, which would otherwise be caused when the balls are scooped up, can be prevented. Moreover, unlike the case of the ball screw of end cap type, the number of ball circulation circuits is not limited to the number of thread grooves. Hence, load capacity can be increased without involvement of an increase in the number of balls per circuit.

Moreover, the side cap is covered with the sound insulation member, or the sound insulation member is provided in the side cap by means of insert molding. Hence, noise developing in the nut and escaping to the outside by propagating through the side cap can be diminished.

Further, when the side cap is covered with the sound insulation member, a sound absorbing member is interposed between the side cap and the sound insulation member, thereby enhancing the noise reduction effect.

In addition, when the sound insulation member is provided in the side cap by means of insert molding, the number of components can be reduced. Hence, when the side cap is split for facilitating formation of a ball circulation path in the side cap and the thus-split pieces of the side cap are subsequently joined, the sound insulation member can be made effective.

### BRIEF DESCRIPTION OF THE DRAWINGS

FIG. 1 is a side view of a ball screw according to a first embodiment of the invention;

FIG. 2 is an axial cross-sectional view of the ball screw shown in FIG. 1;

FIG. 3 is a radial cross-sectional view of the ball screw shown in FIG. 1;

FIG. 4 is a plan view of the side cap shown in FIG. 1;

FIG. 5 is a front view of the side cap shown in FIG. 4;

FIG. 6 is a side view of the side cap shown in FIG. 5;

FIG. 7 is a plan view of a side-cap-constituting member shown in FIG. 4;

FIG. 8 is a front view of the side-cap-constituting member shown in FIG. 7;

FIG. 9 is a bottom view of the side-cap-constituting member shown in FIG. 7;

FIG. 10 is a left side view of the side-cap-constituting member shown in FIG. 7;

FIG. 11 is a right side view of the side-cap-constituting member shown in FIG. 7;

FIG. 12 is a view showing a side cap of a ball screw according to a second embodiment of the invention;

FIG. 13 is a side view of a ball screw according to a third embodiment of the invention;

FIG. 14 is a cross-sectional view of the ball screw taken along line XIV-XIV shown in FIG. 13;

FIG. 15 is a perspective view of the nut and the side cap shown in FIG. 14;

FIG. 16 is a side view of a ball screw according to a fourth embodiment of the invention;

FIG. 17 is a cross-sectional view of the ball screw taken along line XVII-XVII shown in FIG. 16;

FIG. 18 is a side view of a ball screw according to a fifth embodiment of the invention;

FIG. 19 is a cross-sectional view of the ball screw taken along line XIX-XIX shown in FIG. 18;

FIG. 20 is a plan view of the side cap shown in FIG. 19;

FIG. 21 is a side view of the side cap shown in FIG. 19;

FIG. 22 is a bottom view of the side cap shown in FIG. 19;

FIG. 23 is a front view of the side cap shown in FIG. 19;

FIG. 24 is a plan view of a side-cap-constituting member shown in FIG. 20;

FIG. 25 is a side view of the side-cap-constituting member shown in FIG. 20;

FIG. 26 is a bottom view of the side-cap-constituting member shown in FIG. 20;

FIG. 27 is a front view of the side-cap-constituting member shown in FIG. 20;

FIG. 28 is a rearview of the side-cap-constituting member shown in FIG. 20;

FIG. 29 is a side view of a ball screw according to a sixth embodiment of the invention;

FIG. 30 is a side view of a ball screw according to a seventh embodiment of the invention;

FIG. 31 is a radial cross-sectional view of the ball screw of the seventh embodiment;

FIG. 32 is a view showing the nut shown in FIG. 30;

FIG. 33 is a cross-sectional view of the nut taken along line XXXIII-XXXIII shown in FIG. 32;

FIG. 34 is a side view of a ball screw according to an eighth embodiment of the invention;

FIG. 35 is an axial cross-sectional view of the ball screw of the eighth embodiment;

FIG. 36 is a radial cross-sectional view of the ball screw of the eighth embodiment;

FIG. 37 is a plan view of the side cap shown in FIG. 34;

FIG. 38 is a side view of the side cap shown in FIG. 37;

FIG. 39 is a plan view of a side-cap-constituting member shown in FIG. 37;

FIG. 40 is a side view of the side-cap-constituting member shown in FIG. 39;

FIG. 41 is a front view of the side-cap-constituting member shown in FIG. 40;

FIG. 42 is a cross-sectional view of the side-cap-constituting member taken along line A-A shown in FIG. 40;

FIG. 43 is a cross-sectional view of the side cap taken along line B-B shown in FIG. 38;

FIGS. 44A and 44B are views showing a border section between a first plane section and a second plane section, both sections shown in FIG. 40, when viewed obliquely;

FIG. 45 is a view of a ball screw according to a ninth embodiment of the invention;

FIG. 46 is a view showing a ball screw according to a tenth embodiment of the invention;

FIGS. 47A to 47D are views showing a side-cap-constituting member of a ball screw according to an eleventh embodiment of the invention;

FIG. 48 is a plan view of a ball screw according to a twelfth embodiment of the invention;

FIG. 49 is an axial cross-sectional view of the ball screw shown in FIG. 48;

FIG. 50 is a plan view of the nut shown in FIG. 48;

FIG. 51 is a plan view of a side cap of the ball screw shown in FIG. 48;

FIG. 52 is a side view of the side cap shown in FIG. 51;

FIG. 53 is a front view of the side cap shown in FIG. 51;

FIG. 54 is a bottom view of the side cap shown in FIG. 51;

FIG. 55 is a cross-sectional view showing a portion of the ball screw shown in FIG. 48;

FIG. 56 is a view showing a border between a ball load raceway and a ball return guide channel, both shown in FIG. 55;

FIG. 57 is a view for describing the operation and advantage of the ball screw of the twelfth embodiment;

FIG. 58 is a view for describing the operation and advantage of the ball screw of the twelfth embodiment;

FIG. 59 is a view showing a border between a ball load raceway and a ball return guide channel, both shown in FIG. 58;

FIGS. 60A to 60C show a ball screw according to a thirteenth embodiment of the invention, wherein FIG. 60A is a plan view of a side cap; FIG. 60B is a front view of the side cap; and FIG. 60C is a side view of the side cap;

FIGS. 61A to 61C show an example of a side-cap-constituting member shown in FIGS. 60A to 60C, wherein FIG. 61A is a plan view, FIG. 61B is a front view, and FIG. 61C is a view when viewed in the direction of arrow “b” shown in FIG. 62B;

FIGS. 62A to 62C show an example of the side-cap-constituting member shown in FIG. 60, wherein FIG. 62A is a front view, FIG. 62B is a bottom view, and FIG. 62C is a view when viewed in the direction of arrow “c” shown in FIG. 62A;

FIG. 63 is a plan view of a ball screw according to a fourteenth embodiment of the invention;

FIG. 64 is a axial cross-sectional view of the ball screw shown in FIG. 63;

FIG. 65 is a fragmentary cross-sectional side view of a ball circulation member shown in FIG. 63;

FIG. 66 is a view for describing vertical insertion of the ball circulation member shown in FIG. 63 into the nut;

FIG. 67 is a view for schematically showing a direction in which balls are to be diverted upward;

FIG. 68 is a view showing a noise characteristic of the ball screw shown in FIG. 63;

FIG. 69 is a plan view of a ball screw according to a fifteenth embodiment of the invention;

FIG. 70 is an axial cross-sectional view of the ball screw shown in FIG. 69;

FIG. 71 is a fragmentary cross-sectional side view of a ball circulation member shown in FIG. 69;

FIG. 72 is a plan view of a circulation-section-constituting member shown in FIG. 69;

FIG. 73 is a side view of the circulation-section-constituting member shown in FIG. 72;

FIG. 74 is a view showing a ball circulation member of a ball screw according to a sixteenth embodiment of the invention;

FIG. 75 is a view showing a ball screw according to a seventeenth embodiment of the invention;

FIGS. 76A and 76B are drawings showing a nut of a ball screw of side cap type which is an embodiment of the invention, wherein FIG. 76A is an exploded perspective view showing a sound insulation member before it is attached to a side cap, and FIG. 76B is a perspective view showing the sound insulation member after it has been attached to the side cap;

FIG. 77 is a view of a nut when viewed from an axial end section of the nut while the sound insulation member is attached to the side cap;

FIG. 78 is a view of a nut belonging to a ball screw of side cap type according to another embodiment of the invention when viewed from an axial end section of the nut;

FIG. 79 is a view of a nut belonging to a ball screw of side cap type according to still another embodiment of the invention when viewed from an axial end section of the nut;

FIG. 80 is a plan view for describing a ball screw of side cap type; and

FIG. 81 is a view of the ball screw when viewed from a right-end section in an axial direction of FIG. 80.

### DETAILED DESCRIPTION OF THE PREFERRED EMBODIMENTS

Embodiments of the present invention will be described hereinbelow by reference to the drawings.

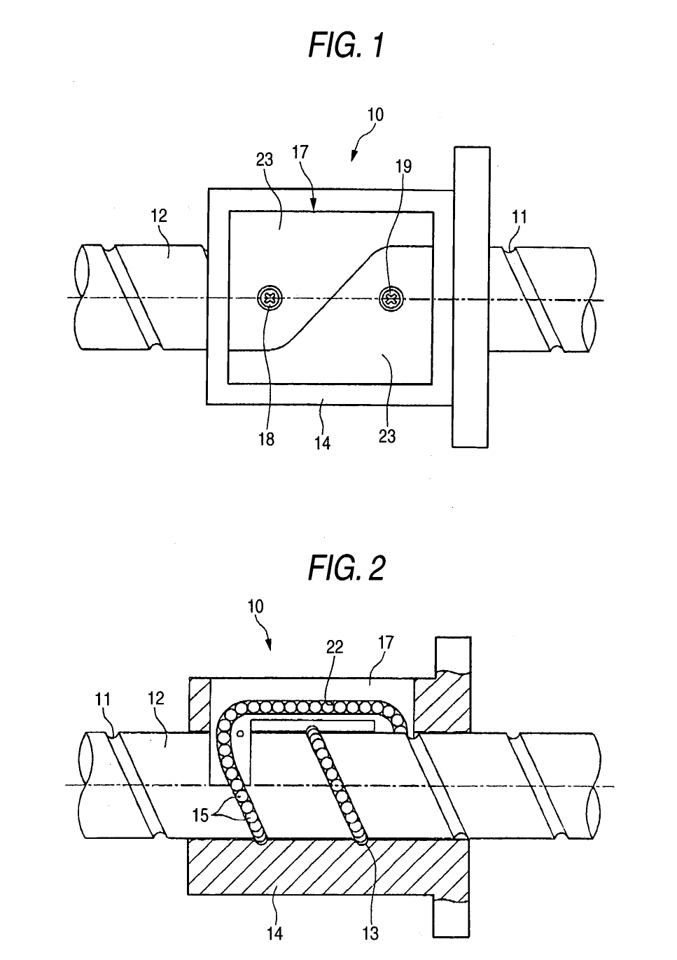

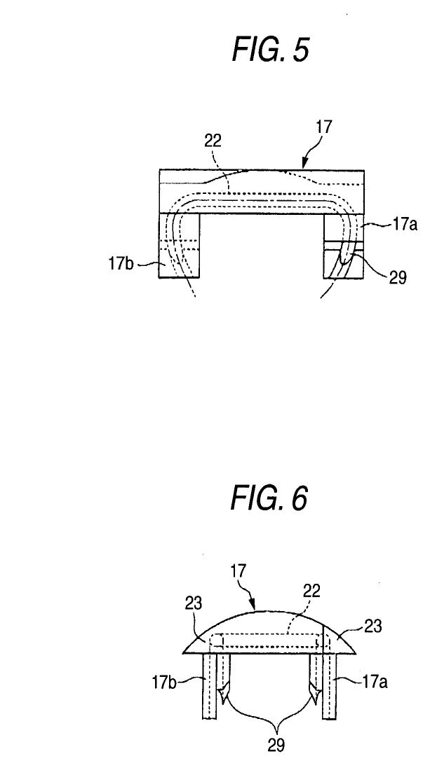

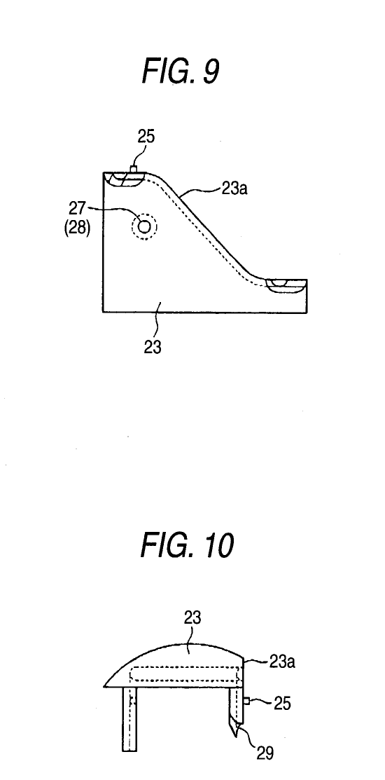

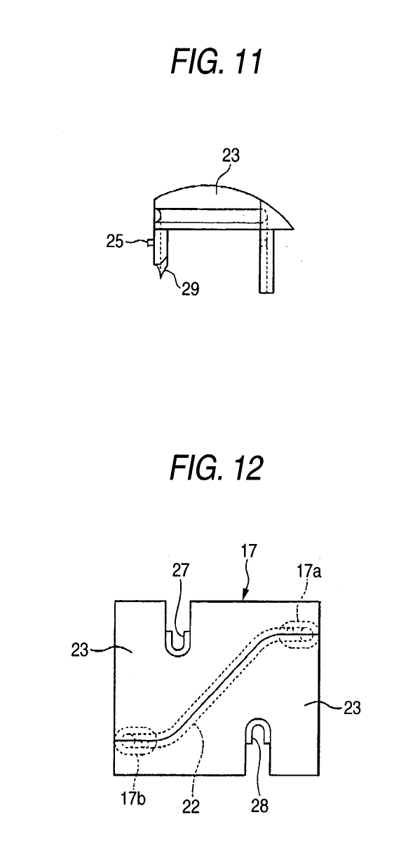

FIGS. 1 through 11 show a first embodiment of the present invention. As shown in FIGS. 1 through 3, a ball screw 10 according to a first embodiment of the present invention comprises a screw shaft 12, on whose outer periphery a ball thread groove 11 is formed; a nut 14, on whose inner periphery a ball thread groove 13 is formed so as to oppose the outer peripheral surface of the screw shaft 12; and a plurality of balls 15 disposed between the ball thread groove 11 of the screw shaft 12 and the ball thread groove 13 of the nut 14. An output shaft of a motor. (not shown) is connected to one end of the screw shaft 12 by way of a coupling.

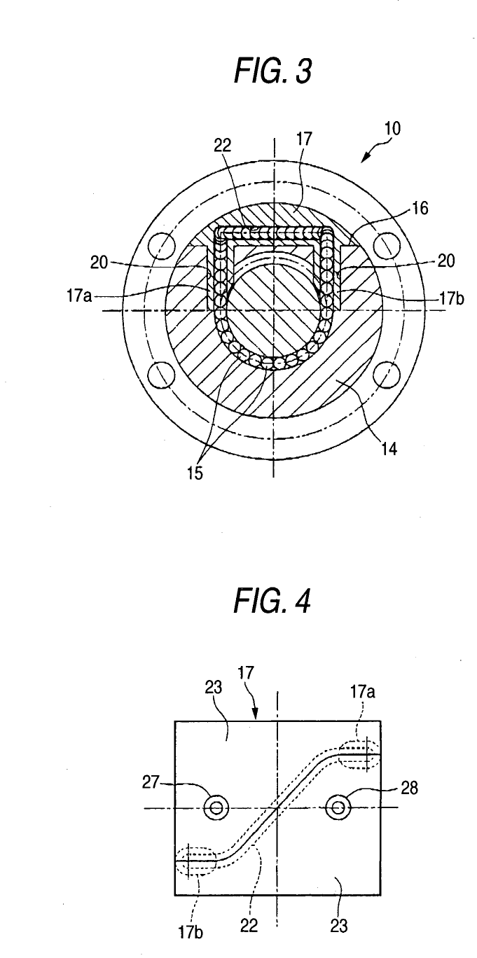

A rectangular side cap mount surface 16 is formed in an outer peripheral surface of the nut 14 (see FIG. 3). A side cap 17 serving as a ball circulation member is attached to the side cap mount surface 16 by means of lock-screws 18, 19 (see FIG. 1).

The side cap 17 has parts 17a, 17b for scooping balls 15 up (hereinafter called “ball scooping parts 17a, 17b”) (see FIG. 3). The ball scooping parts 17a, 17b are inserted into ball circulation holes 20, 20 opened in the side cap mount surface 16. The side cap 17 is formed from, e.g., resin. A ball return path 22 is formed in the side cap 17 for scooping the balls 15 up in a direction matching the lead angles of the ball thread grooves 11, 13 and returning the balls 15 to the initial position (see FIGS. 2 and 3). The side cap 17 is formed from a pair of side-cap-constituting members 23, 23 molded from, e.g., resin, (see FIGS. 4 through 6). The ball return path 22 is divided into two parts with reference to the traveling direction of the balls 15, by means of the side-cap-constituting members 23, 23.

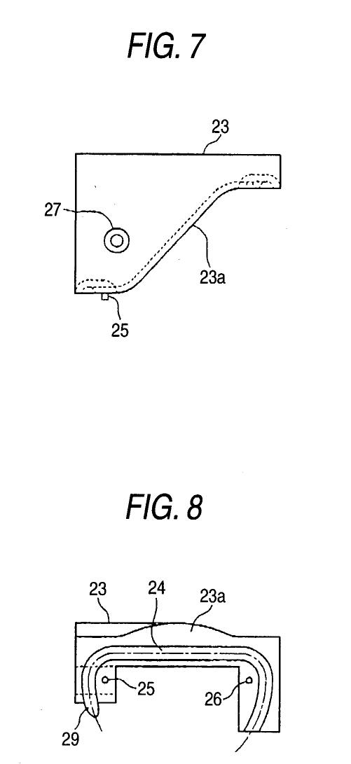

As shown in FIGS. 7 through 10, each of the side-cap-constituting members 23 has a mating surface (butting surface) 23a. A groove part 24 is formed in the mating surface 23a of each side-cap-constituting member 23 for forming the ball return path 22 of the side cap 17. Further, a protrusion 25 and a hole 26 (see FIG. 8) are formed on and in the mating surface 23a for positioning. Side cap mount holes 27, 28 (see FIG. 4) are drilled in the side cap 17 for insertion of the lock-screws 18, 19. Further, tongue parts 29 (see FIG. 6) are formed in the respective ball scooping parts 17a, 17b of the side cap 17 for guiding the balls 15 to the ball return path 22.

As mentioned above, when the side cap 17 is attached to the side cap mount surface 16 of the nut 14, the balls 15 rolling between the ball thread grooves 11, 13 are scooped up by the ball scooping part 17a or 17b of the side cap 17 in the direction matching the lead angles of the ball thread grooves 11, 13. The thus-scooped balls 15 are then guided to the ball return path 22. According to the first embodiment, unlike the case of the ball screw of tube circulation type, the traveling direction of the balls does not change abruptly at a ball circulation part even when leads of the ball thread grooves 11, 13 become large. Hence, occurrence of damage to balls or noise, which would otherwise be caused when balls are scooped up, can be prevented. Unlike the case of the ball screw of end cap type, the number of ball circulation circuits is not limited to the number of thread grooves. Hence, load capacity can be increased without involvement of an increase in the number of balls (windings) per circuit.

In the first embodiment, the ball return path 22 is split into two parts with reference to the traveling direction of the balls 15. Hence, the ball return path 22, which scoops the balls 15 up in the direction matching the lead angles of the ball thread grooves 11, 13 and returning the balls 15 to the initial position, can be formed readily in the side cap 17.

Unlike the case of the ball screw of tube circulation type, provision of a tube press or the like in addition to the ball circulation tube is not required. Hence, the number of components can be curtailed. As a result, an attempt can be made to simplify a construction and reduce assembly costs. The side cap 17 is formed by a pair of side-cap-constituting members 23, 23, which are identical in outer shape. Hence, the side-cap-constituting members 23, 23 can be molded with forming dies. Accordingly, the side cap 17 can be manufactured easily.

In the embodiment, the ball return path 22 is split into two parts with reference to the traveling direction of the balls 15. However, division of the ball return path 22 into two parts is not always required. For instance, the ball return path 22 may be divided into three or more parts with reference to the traveling direction of the balls 15. Moreover, in the embodiment the side cap 17 is formed from resin. However, the side cap 17 maybe formed from sintered material, such as sintered steel, or may be formed by means of metal injection molding (MIM). By means of such a construction, when the ball screw is formed into a nut rotation type, rotational balance of the nut can be maintained stably. Further, the ball screw can be used under high temperatures suitable for use with resin.

FIG. 12 shows a second embodiment of the present invention. The second embodiment differs from the first embodiment in that the side cap mount holes 27, 28 to be used for enabling insertion of the lock-screws 18, 19 assume the form of slit holes. In other respects, the second embodiment is structurally identical with the first embodiment.

Thus, the side cap 17 can be readily produced by means of injection molding or sintering, by means of forming the side cap mount holes 27, 28 in the form of slit holes.

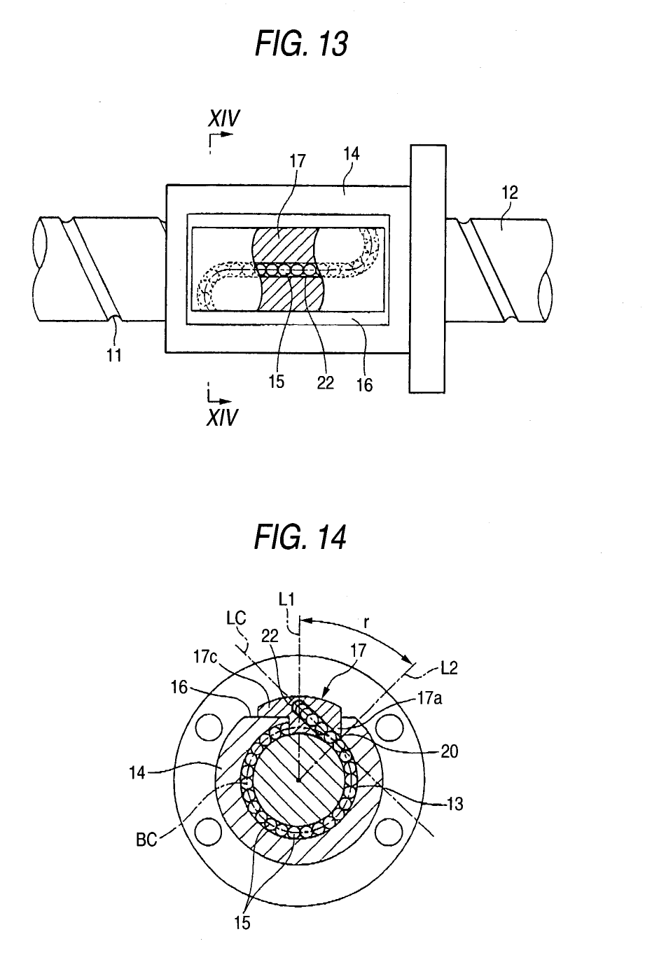

FIGS. 13 through 15 show a third embodiment of the present invention. FIG. 13 is a side view showing a ball screw of the third embodiment. FIG. 14 is a cross-sectional view of the ball screw taken along line XIV-XIV when viewed in the direction indicated by arrows. As illustrated, the ball screw of the third embodiment has the screw shaft 12, and the cylindrical nut 14 to be screw-engaged with the outer peripheral surface of the screw shaft 12. The ball thread groove 11 is formed in the outer peripheral surface of the screw shaft 12, and opposes the ball thread groove 13 formed in the inner peripheral surface of the nut 14 (see FIG. 14). When either the screw shaft 12 or the nut 14 is rotated, the plurality of balls 15 provided in the space defined between the ball thread grooves 11, 13 roll over the helical ball load rotation path defined between the ball thread grooves 11, 13.

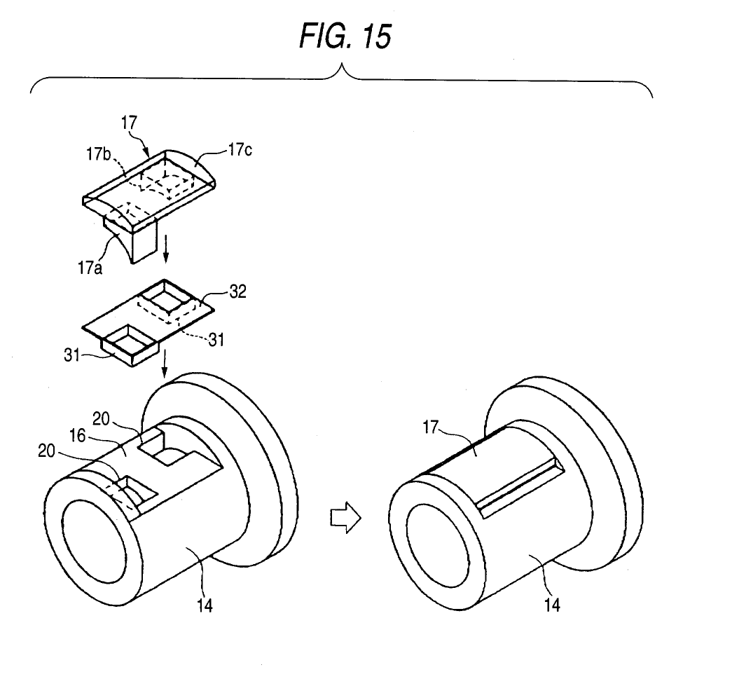

The ball screw of the third embodiment has the side cap 17 serving as a ball circulation member. The side cap 17 has a block-shaped side cap main body 17c having the ball return path 22 to be used for returning the balls 15 to the initial position (see FIG. 14). The side cap 17 also has the ball scooping parts 17a, 17b, which are prismatic (see FIG. 15 for the ball scooping part 17b) and which scoop up, through a phase angle “r” smaller than 90°, the balls 15 rolling between the ball thread grooves 11, 13, to thereby guide the balls 15 to the ball return path 22. The side cap main body 17c is fastened to the side cap mount surface 16 formed in the outer peripheral surface of the nut 14. Here, the phase angle “r” is formed between a line L1, which is perpendicular to the side cap mount surface 16 and passes through the center of the screw shaft 12, and a straight line L2 connecting the center of the screw shaft 12 with a position where the side cap main body 17c is to divert the balls 15 up.

The ball scooping parts 17a, 17b are inserted into the nut 14 by way of the ball circulation holes 20, 20 formed in the side cap mount surface 16. The balls 15 rolling between the ball thread grooves 11, 13 are scooped up by the ball scooping part 17a or 17b. Subsequently, the balls 15 return to the initial position by way of the ball return path 22. Here, the side cap 17 is molded by means of injection molding, e.g., resin.

FIG. 15 is a view for showing the principal parts of the ball screw of the third embodiment. As illustrated, cushioning members 31, such as rubber or sponge, are interposed between the ball scooping parts 17a, 17b of the side cap 17 and the ball circulation holes 20, 20 of the nut 14, respectively. The cushioning members 31 are formed into the shape of a rectangular duct. A sheet-like elastic member 32 is formed integrally at one end of each cushioning member 31. The elastic member 32 is formed from elastic material, such as rubber or sponge, and is interposed between the side cap mount surface 16 of the nut 14 and the side cap 17.

In this way, if the cushioning members 31 formed from a cushioning material, such as rubber or sponge, are interposed between the ball scooping parts 17a, 17b of the side cap 17 and the ball circulation holes 20, 20 of the nut 14, respectively, the impact force exerted on the side cap 17 by the balls 15 is transmitted to the nut 14 after having been absorbed by the cushioning members 31. Accordingly, the impact force exerted on the side cap 17 by the balls 15 is not transmitted in its present form to the nut 14 as excitation force. Therefore, occurrence of noise or vibration, which would otherwise be caused by the impact force exerted on the side cap 17 by the balls 15, can be prevented.

Specifically, in the case of the related-art ball screw, when the balls collide with the ball scooping parts of the side cap when passing by the ball return path of the side cap, the impact force applied by the balls acts on the side cap as excitation force. The excitation force is transmitted directly to the nut 14, thereby often causing noise or vibration. In contrast, in the embodiment, the excitation force acting on the side cap 17 is transmitted to the nut 14 after having been absorbed by the cushioning member 31. Hence, occurrence of noise or vibration, which would otherwise be caused by the excitation force acting on the side cap 17, can be prevented.

In the case of this embodiment, if the ball return path 22 in the side cap 17 is clogged with the balls 15 as a result of the elastic member 32 being interposed between the side cap mount surface 16 of the nut 14 and the side cap 17, the length of the ball return path 22 is extended by slight rotation of the side cap 17, thereby releasing the pushing force exerted by the balls 15. Thus, the clogging is overcome, thereby achieving an improvement in operability of the ball screw and preventing infliction of damage to the balls, which would otherwise be caused by collision.

In the third embodiment, the ball scooping parts 17a, 17b of the side cap 17 are formed into a prismatic shape. However, circular or oval ball circulation holes are formed in the side cap mount hole 16 of the nut 14. The shapes of the ball scooping parts 17a, 17b may be changed to a columnar shape or an elliptic columnar shape in agreement with the shapes of the ball circulation holes 20, thereby preventing concentration of stress on the nut 14.

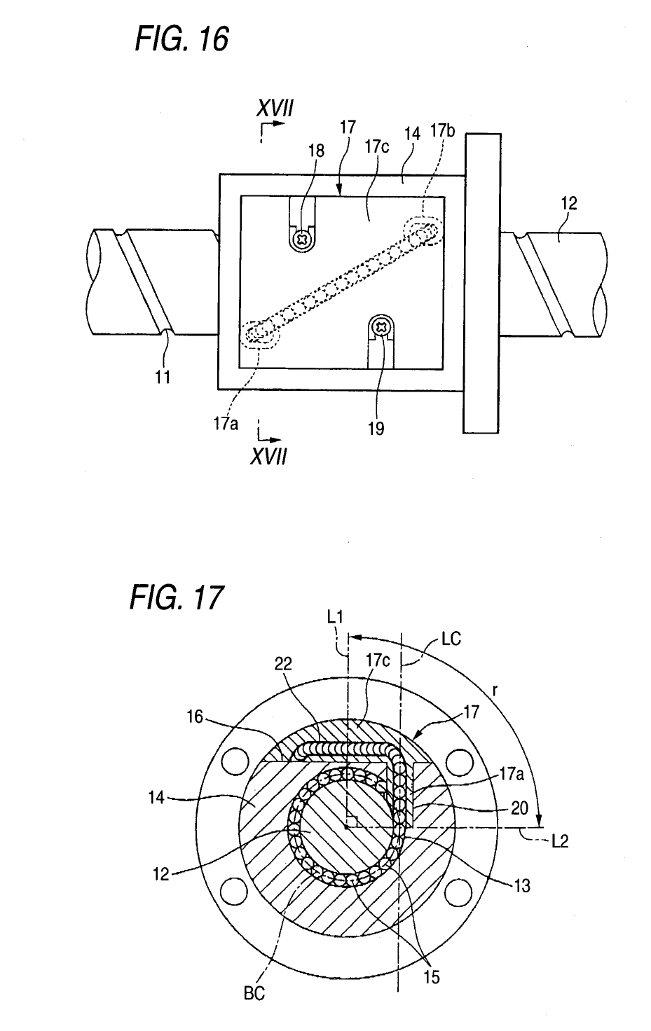

FIGS. 16 and 17 show a fourth embodiment of the present invention. FIG. 16 is a side view of a ball screw of the fourth embodiment, and FIG. 17 is a cross-sectional view of the ball screw taken along line XVII-XVII shown in FIG. 16. As illustrated, the ball screw of the fourth embodiment has the screw shaft 12, and the cylindrical nut 14 to be screw-engaged with the outer peripheral surface of the screw shaft 12. The ball thread groove 11 is formed in the outer peripheral surface of the screw shaft 12, and opposes the ball thread groove 13 formed in the inner peripheral surface of the nut 14 (see FIG. 17). When the screw shaft 12 or the nut 14 is rotated, the plurality of balls 15 interposed between the ball thread grooves 11, 13 roll over a helical ball loaded rolling groove defined between the ball thread grooves 11, 13.

The ball screw of the fourth embodiment has the side cap 17 serving as a ball circulation member. The side cap 17 has the block-shaped side cap main body 17c having the ball return path 22 for returning the balls 15 to the initial position. The side cap 17 also has the prismatic ball scooping parts 17a, 17b which scoop up the balls 15 rolling between the ball thread grooves 11, 13 toward the direction of a tangential line LC tangent to a centroid circle BC of centers of the balls 15 and which guide the balls 15 to the ball return path 22. The side cap main body 17c is fastened to the side cap mount surface 16 formed in the outer peripheral surface of the nut 14, by means of the lock-screws 18, 19.

The ball scooping parts 17a, 17b are inserted into the nut 14 by way of the ball circulation holes 20, 20 formed in the side cap mount surface 16. The balls 15 rolling between the ball screw grooves 11, 13 return to the initial position by way of the ball return path 22 after having been upwardly scooped by the ball scooping part 17a or 17b. The side cap 17 is formed from, e.g., resin material, by means of injection molding.

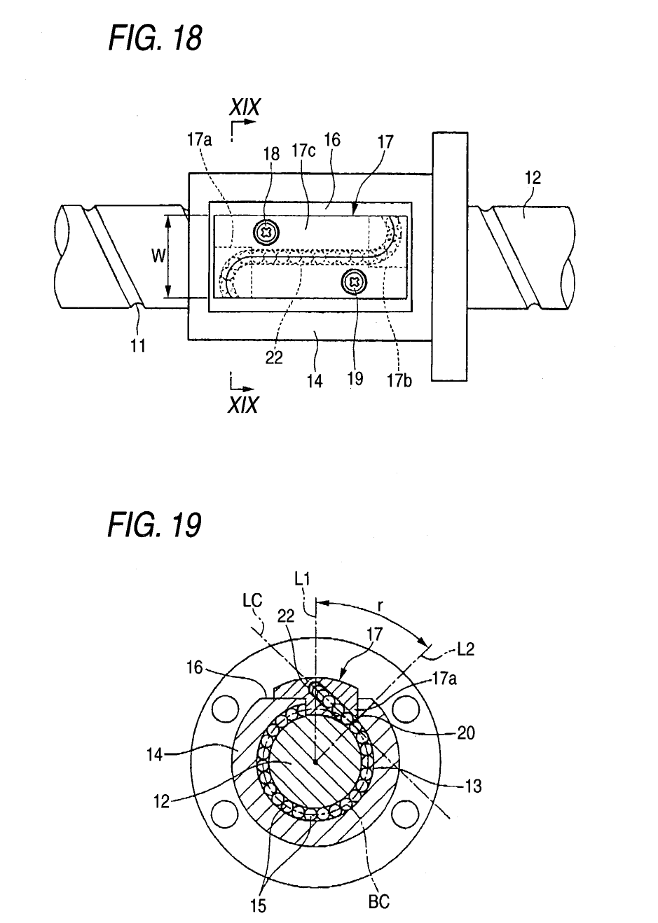

FIGS. 18 through 28 show a fifth embodiment of the present invention. FIG. 18 is a side view of a ball screw of the fifth embodiment, and FIG. 19 is a cross-sectional view of the ball screw taken along line XIX-XIX shown in FIG. 18. As illustrated, the ball screw of the fifth embodiment has the screw shaft 12, and the cylindrical nut 14 to be screw-engaged with the outer peripheral surface of the screw shaft 12. The ball thread groove 11 is formed in the outer peripheral surface of the screw shaft 12, and opposes the ball thread groove 13 formed in the inner peripheral surface of the nut 14 (see FIG. 19). When the screw shaft 12 or the nut 14 is rotated, the plurality of balls 15 interposed between the ball thread grooves 11, 13 roll over a helical ball loaded rolling groove defined between the ball thread grooves 11, 13.

The ball screw of the fifth embodiment has the side cap 17 serving as a ball circulation member. The side cap 17 has the block-shaped side cap main body 17c having the ball return path 22 for returning the balls 15 to the initial position. The side cap 17 also has the prismatic ball scooping parts 17a, 17b which scoop up the balls 15 rolling between the ball thread grooves 11, 13 toward the direction of the tangential line LC tangent to a centroid circle BC of centers of the balls 15 at a phase angle “r” smaller than 90° and which guide the balls 15 to the ball return path 22. The side cap main body 17c is fastened to the side cap mount surface 16 formed in the outer peripheral surface of the nut 14, by means of the lock-screws 18, 19.

The ball scooping parts 17a, 17b are inserted into the nut 14 by way of the ball circulation holes 20, 20 formed in the side cap mount surface 16. The balls 15 rolling between the ball screw grooves 11, 13 return to the initial position by way of the ball return path 22 after having been scooped up by the ball scooping part 17a or 17b. The side cap 17 is formed from, e.g., resin material, by means of injection molding.

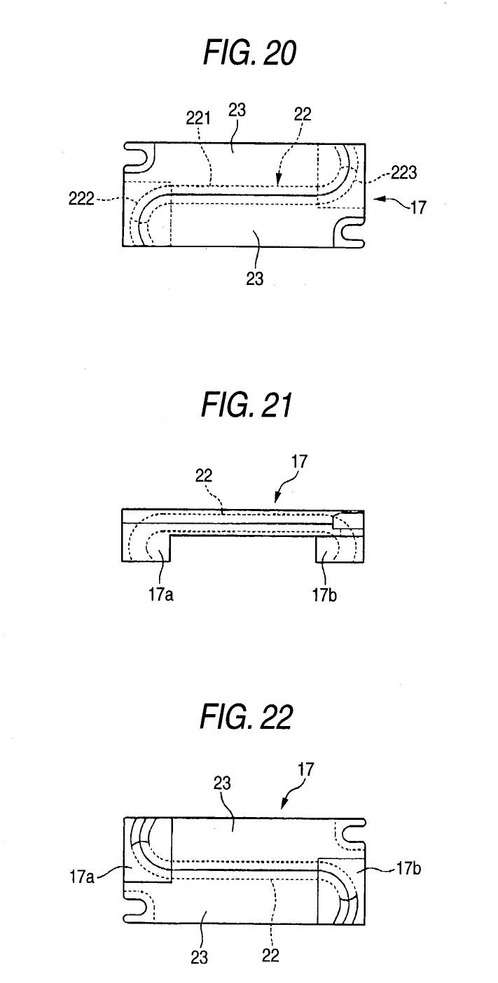

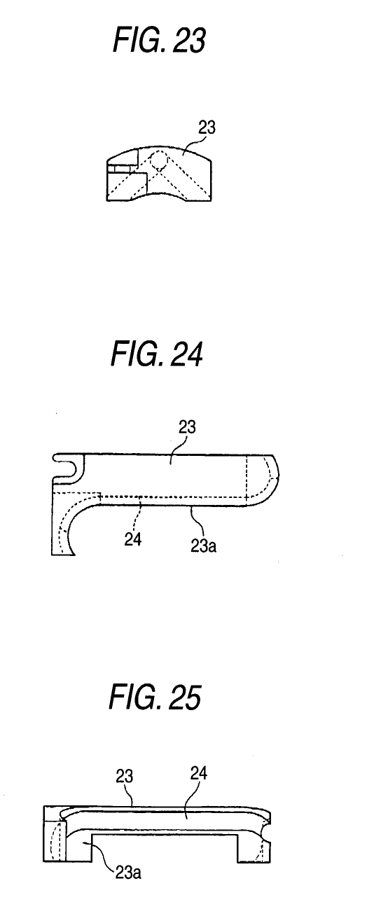

FIG. 20 is a plan view of the side cap 17; FIG. 21 is a side view of the side cap 17; FIG. 22 is a bottom view of the side cap 17; and FIG. 23 is a front view of the side cap 17. As illustrated, the side cap 17 is formed from a pair of side-cap-constituting members 23, 23, which are molded from, e.g., resin material. The ball return path 22 formed in the side cap 17 is formed from a linear part 221 and curved parts 222, 223 formed so as to extend continuously from the respective ends of the linear part 221. The linear part 221 is provided in parallel with the screw shaft 12 in the center of the side cap 17.

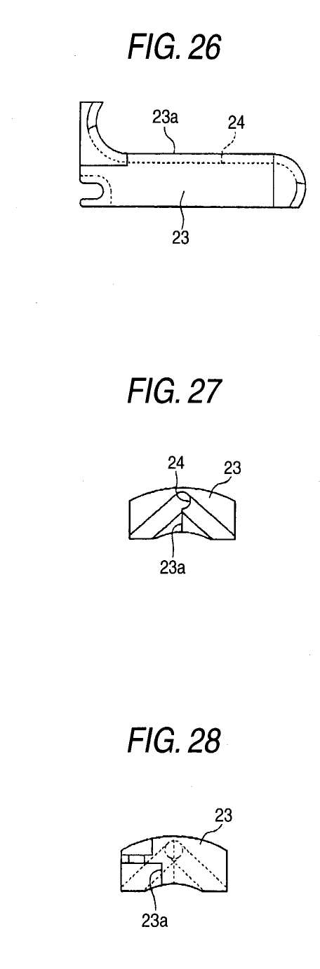

FIGS. 24 through 28 are views showing the side-cap-constituting member 23. FIG. 24 is a plan view of the side-cap-constituting member 23. FIG. 25 is a side view of the side-cap-constituting member 23. FIG. 26 is a bottom view of the side-cap-constituting member 23. FIG. 27 is a front view of the side-cap-constituting-member 23. FIG. 28 is a rear view of the side-cap-constituting-member 23. As illustrated, the side-cap-constituting-members 23 each have the mating surface (butting surface) 23a. The groove part 24 is formed in the mating surface 23a of each side-cap-constituting-member 23 for forming the ball return path 22 of the side cap 17.

As mentioned, the linear part 221 of the ball return path 22 is provided in the center of the side cap 17 in parallel with the screw shaft 12. As shown in FIG. 19, the phase angle “r” of the position where balls are to be scooped up (hereinafter called a “ball scooping position”) becomes smaller than that of the ball screw shown in FIG. 17. As a result, the number of active coils of the ball thread groove 13 formed in the inner peripheral surface of the nut 14 becomes larger, thereby increasing the load capacity of the ball screw. Specifically, the linear part of the ball return path 22 in the ball screw shown in FIG. 17 is inclined toward the screw shaft 12. Hence, the phase angle “r” of the ball scooping position (made between the straight line L1 which is perpendicular to the side cap mount surface 16 of the nut 14 and passes through the center of the screw shaft 12 and the straight line L2 passing through the center of the screw shaft 12 and the position where the balls 15 are to be scooped up) assumes an angle of about 90°. Therefore, the number of active coils of the ball thread groove 13 formed in the inner peripheral surface of the nut 14 assumes a value formed by subtracting 0.5 coils from an integer, such as 1.5 coils or 2.5 coils. The phase between the nut 14 and the side cap 17 differs from that between the nut 14 and the opposite side of the side cap 17 in terms of the number of balls which undergo load. Hence, axial unbalance of rigidity develops. In contrast, according to the fifth embodiment, the linear part 221 of the ball return path 22 is provided in the center of the side cap 17 in parallel with the screw shaft 12. Hence, the phase angle “r” becomes small. The number of active coils of the ball thread groove 13 formed in the inner peripheral surface of the nut 14 comes close to an integer (e.g., 1.7 coils or 2.7 coils). Hence, unbalance in rigidity can be made small, thereby increasing the load capacity of the ball screw.

In the ball screw shown in FIG. 17, the linear part 221 of the ball return path 22 is inclined toward the screw shaft 12. Hence, the side cap 17 assumes a broad-shouldered shape. In contrast, in the fifth embodiment, the linear part 221 of the ball return path 22 is provided in parallel with the screw shaft 12. Hence, the width “w” of the side cap 17 can be reduced (see FIG. 18). As a result, the side cap 17 can be reduced in size, thereby attaining miniaturization of the ball screw.

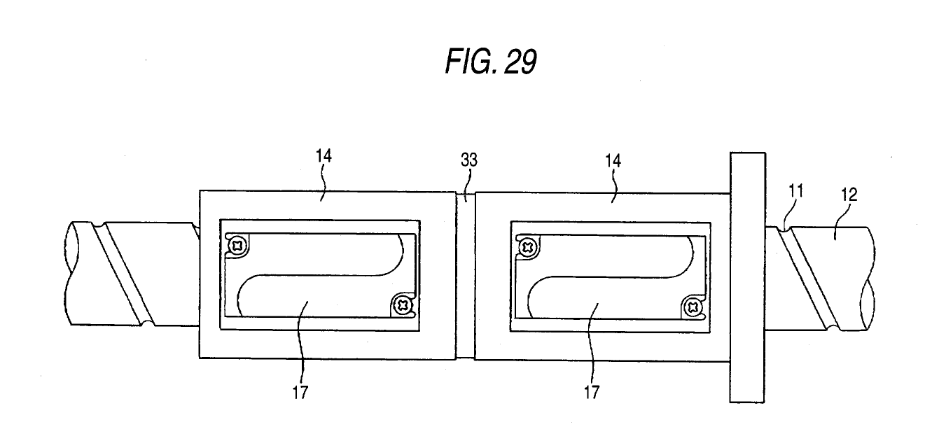

In the fifth embodiment, the ball scooping parts 17a, 17b and the ball return path 22 become similar in construction to those employed in the ball screw of end cap type. Hence, the construction can be applied to a ball screw involving a large lead, which has conventionally been difficult to materialize. Further, in the case of the ball screw of end cap type, a plurality of circulation circuits cannot be provided in parallel with each other, or pre-load (e.g., double-nut pre-load) cannot be applied to the ball screw, although these arrangements are possible in the case of the ball screw of tube type. As in the sixth embodiment shown in FIG. 29, according to the present invention, pre-load (double-nut pre-load) can be applied to the ball screw by combination of the two nuts 14, 14. In FIG. 29, reference numeral 33 designates a spacer interposed between the two nuts 14, 14.

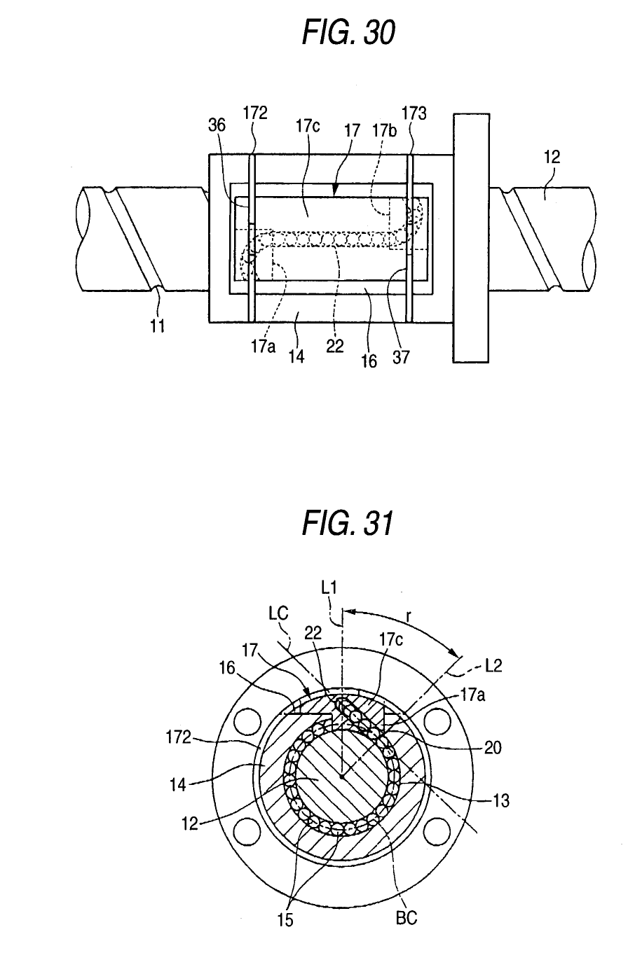

FIGS. 30 through 33 show a seventh embodiment of the present invention. FIG. 30 is a side view of a ball screw according to the seventh embodiment. FIG. 31 is a cross-sectional view of the ball screw of the seventh embodiment taken along the radial direction of the ball screw. As illustrated, the ball screw of the seventh embodiment has the screw shaft 12, and the cylindrical nut 14 to be screw-engaged with the outer peripheral surface of the screw shaft 12. The ball thread groove 11 is formed in the outer peripheral surface of the screw shaft 12, and opposes the ball thread groove 13 formed in the inner peripheral surface of the nut 14 (see FIG. 31). When the screw shaft 12 or the nut 14 is rotated, the plurality of balls 15 interposed between the ball thread grooves 11, 13 roll over a helical ball loaded rolling groove defined between the ball thread grooves 11, 13.

The ball screw of the seventh embodiment has the side cap 17 serving as a ball circulation member. The side cap 17 has the block-shaped side cap main body 17c having the ball return path 22 for returning the balls 15 to the initial position. The side cap 17 also has the ball scooping parts 17a, 17b which scoop up the balls 15 rolling between the ball thread grooves 11, 13 toward the direction of the tangential line LC tangent to a centroid circle BC of centers of the balls 15 through a phase angle “r” smaller than 90° and which guide the balls 15 to the ball return path 22. The side cap main body 17c is fastened to the side cap mount surface 16 formed in the outer peripheral surface of the nut 14 through use of elastic pressing members 172, 173, such as garter springs, rubber bands, C-shaped retaining rings, ring springs, and elastic bands made of nylon.

The ball scooping parts 17a, 17b are inserted into the nut 14 by way of the ball circulation holes 20, 20 formed in the side cap mount surface 16. The balls 15 rolling between the ball screw grooves 11, 13 return to the initial position by way of the ball return path 22 after having been scooped up by the ball scooping part 17a or 17b. The side cap 17 is formed from, e.g., resin material, by means of injection molding.

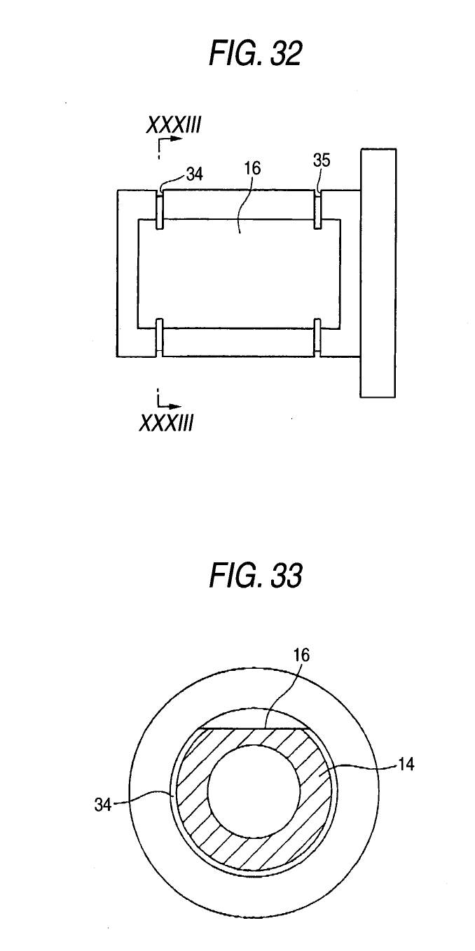

The elastic pressing members 172, 173 are provided on the outer peripheral surface of the nut 14. As shown in FIGS. 32 and 33, grooves 34, 35 are formed in the outer peripheral surface of the nut 14 for accommodating the elastic pressing members 172, 173. Further, grooves 36, 37 (see FIG. 30) are formed in the outer peripheral surface of the side cap 17 for accommodating the elastic pressing members 172, 173.

As mentioned, the elastic pressing members 172, 173 are provided on the outer peripheral surface of the nut 14. When the side cap 17 is pressed against the side cap mount surface 16 formed in the outer peripheral surface of the nut 14 with the elastic pressing members 172, 173, exfoliation of the side cap 17 from the side cap mount surface 16 is inhibited. This eliminates a necessity for forming, in the nut 14, a mount hole to be used for fastening the side cap 17 on the nut 14, thereby eliminating costs incurred for machining the mount hole.

Unlike the case of the ball screw shown in FIG. 17, in the seventh embodiment the heads of the lock-screws 18, 19 project from the outer peripheral surface of the nut 14. Hence, the outer diameter of the nut 14 can be reduced, thereby miniaturizing the ball screw. When being pushed up in the drawing by the balls 15 rolling over the ball return path 22, the side cap 17 is moved upward in the drawing, thereby releasing the pressing force, which would otherwise be exerted on the side cap 17 by the balls 15. As a result, the collision force of the balls is diminished, thereby improving the operability of the ball screw and preventing infliction of damage on the balls.

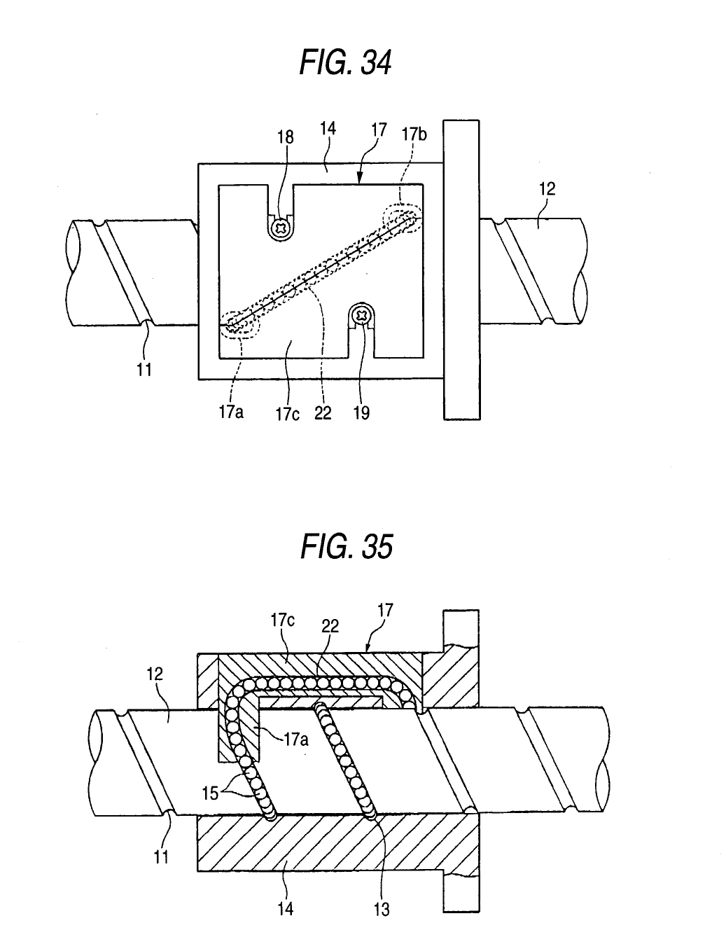

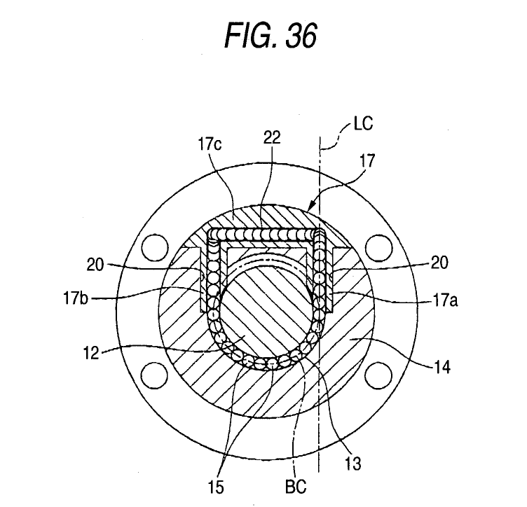

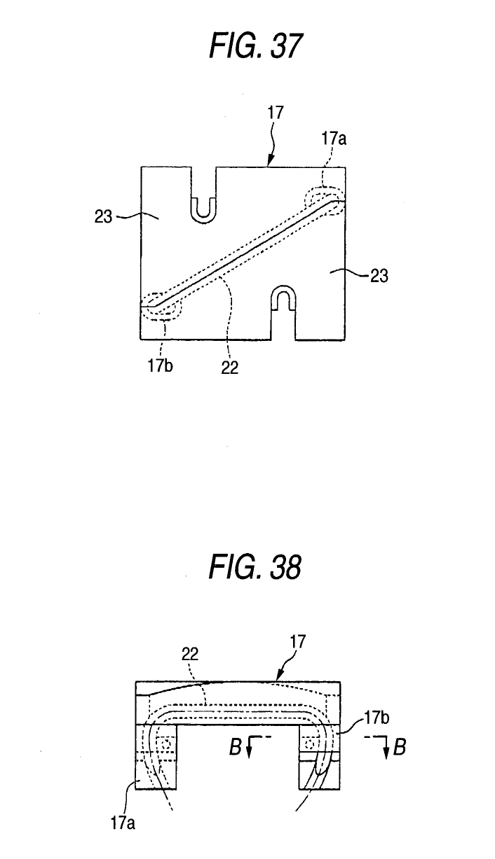

FIGS. 34 through 44 show an eighth embodiment of the present invention. FIG. 34 is a side view of a ball screw according to the eighth embodiment of the present invention. FIG. 35 is a cross-sectional view of the ball screw of the eighth embodiment taken along the axial direction of the ball screw. FIG. 36 is across-sectional view of the ball screw of the eighth embodiment taken along a radial direction of the ball screw. As illustrated, the ball screw of the eighth embodiment has the screw shaft 12, and the cylindrical nut 14 to be screw-engaged with the outer peripheral surface of the screw shaft 12. The ball thread groove 11 is formed in the outer peripheral surface of the screw shaft 12, and opposes the ball thread groove 13 formed in the inner peripheral surface of the nut 14 (see FIGS. 35 and 36). When the screw shaft 12 or the nut 14 is rotated, the plurality of balls 15 interposed between the ball thread grooves 11, 13 roll between the ball thread grooves 11, 13.

The ball screw of the eighth embodiment has the side cap 17 serving as a ball circulation member. The side cap 17 has the block-shaped side cap main body 17c having the ball return path 22 for returning the balls 15 to the initial position. The side cap 17 also has a pair of ball scooping parts 17a, 17b (see FIG. 36) which scoop up the balls 15 rolling between the ball thread grooves 11, 13 toward the direction of the tangential line LC tangent to a centroid circle BC of centers of the balls 15 and which guide the balls 15 to the ball return path 22. The side cap main body 17c is fastened to the side cap mount surface 16 formed on the outer peripheral surface of the nut 14, by means of the lock-screws 18, 19.

The ball scooping parts 17a, 17b are inserted into the nut 14 by way of the ball circulation holes 20, 20 formed in the side cap mount surface 16. The balls 15 rolling between the ball screw grooves 11, 13 return to the initial position by way of the ball return path 22 after having been scooped up by the ball scooping part 17a or 17b.

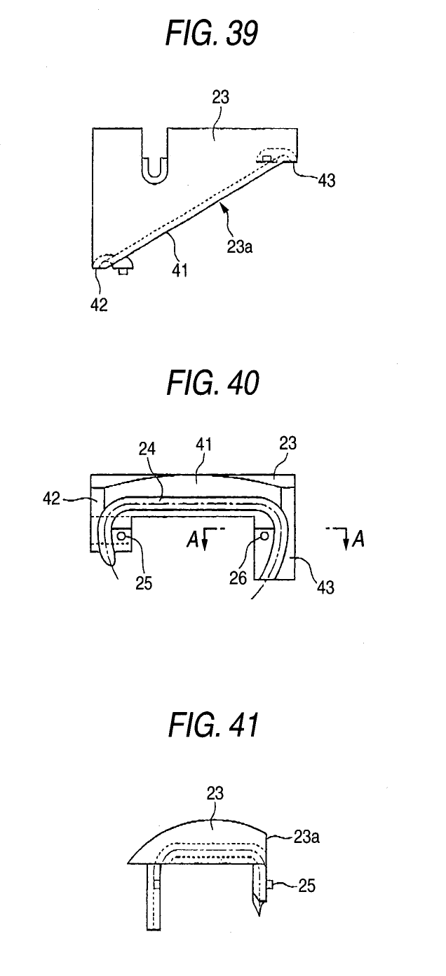

FIG. 39 is a plan view of the side-cap-constituting member 23. FIG. 40 is a side view of the side-cap-constituting member 23. FIG. 41 is a front view of the side-cap-constituting member 23. As illustrated, the side-cap-constituting members 23 each have the mating surface (butting surface) 23a. The mating surface 23a has a first plane part 41 for dividing the side cap main body 17c in a inclined direction with respect to the axial direction of the screw shaft 12; a second plane part 42 for dividing the ball scooping part 17b of the side cap 17 with respect to the axial direction of the screw shaft 12; and a third plane part 43 for dividing the ball scooping part 17a of the side cap 17 with respect to the axial direction of the screw shaft 12. The groove part 24 is formed in the mating surface 23a of each side-cap-constituting-member 23 for forming the ball return path 22 of the side cap 17.

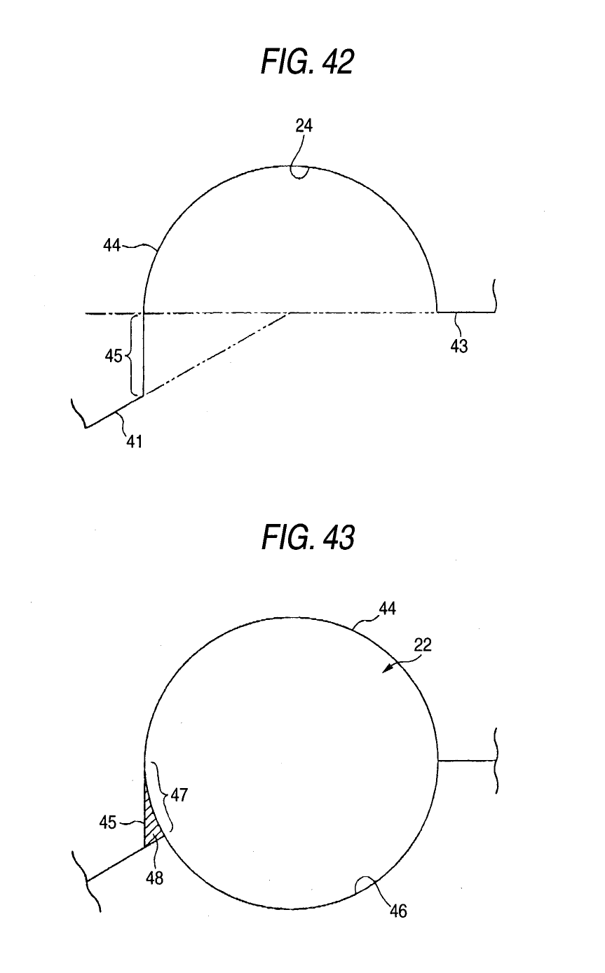

FIG. 42 is a cross-sectional view taken along line A-A shown in FIG. 40. As illustrated, the groove part 24 assumes a cross-sectional profile formed by combination of a semicircle 44 defined between the first plane part 41 and the second plane part 42 with a straight line 45.

FIG. 43 is a cross sectional view taken along line B-B shown in FIG. 38. As illustrated, the ball return path 22 assumes a cross-sectional profile formed by combination of the semicircle 44 defined between the ball scooping parts 17a, 17b and the straight line 45 with circular arcs 46, 47. Hence, a hatched part 48 constitutes a step. If the balls 15 collide with the step part 48, vibration or noise will arise. For this reason, in the case of the ball screw of the present embodiment, the hatched part 48 is chamfered, to thereby prevent occurrence of an angular step on the boundary among the first plane part 41, the second plane part 42, and the third plane part 43.

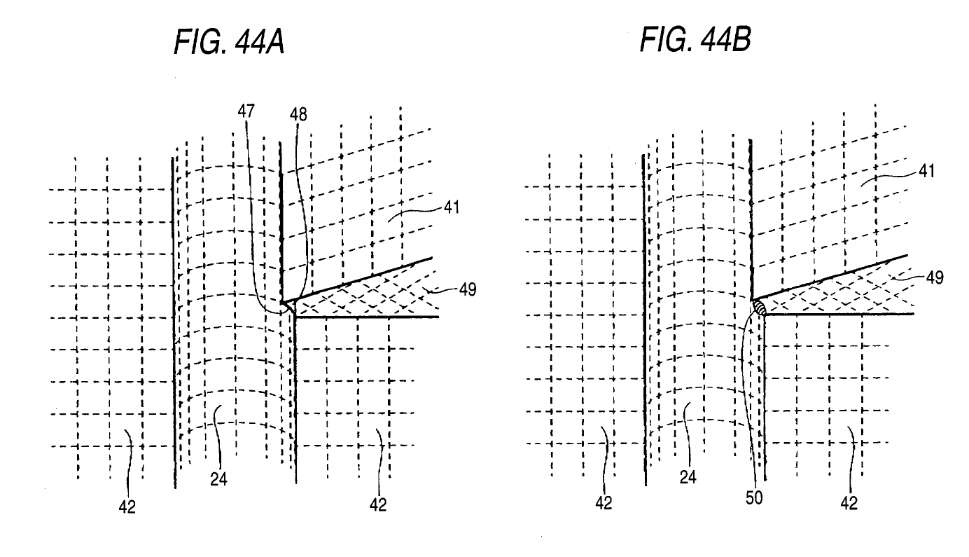

FIGS. 44A and 44B are views of the boundary between the first plane part 41 and the second plane part 42 when viewed in a slanting direction. FIG. 44A shows the boundary before chamfering, and FIG. 44B shows the state after chamfering of the boundary. In the drawings, reference numeral 49 designates a surface formed from a difference in level between the first plane part 41 and the second plane part 42; and 50 designates an area to be chamfered.

As mentioned above, the boundary between the first plane part 41 and the second plane part 42, both belonging to the mating surface 23a, is chamfered, thereby eliminating an angular step arising in the boundary. Since the balls 15 roll smoothly over the boundary, occurrence of vibration or noise can be prevented.

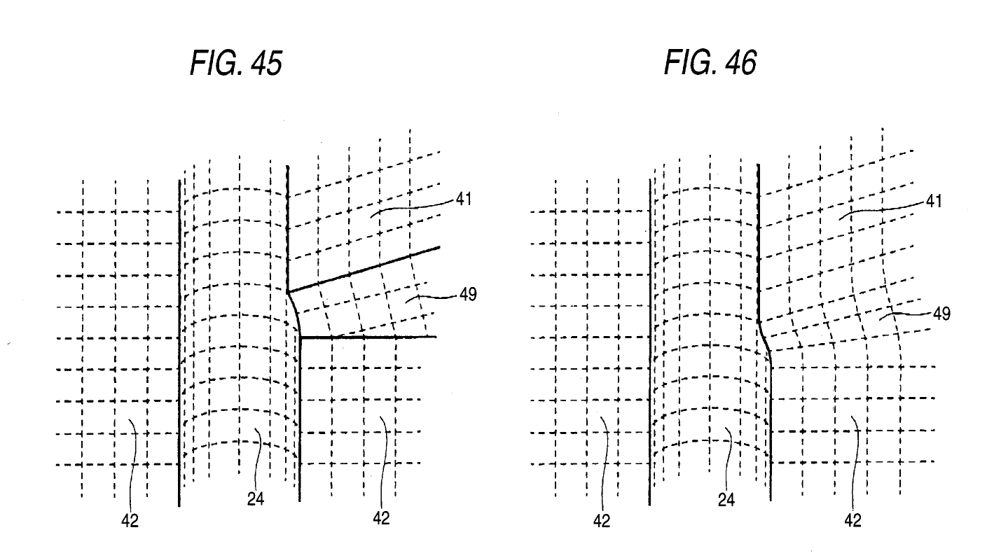

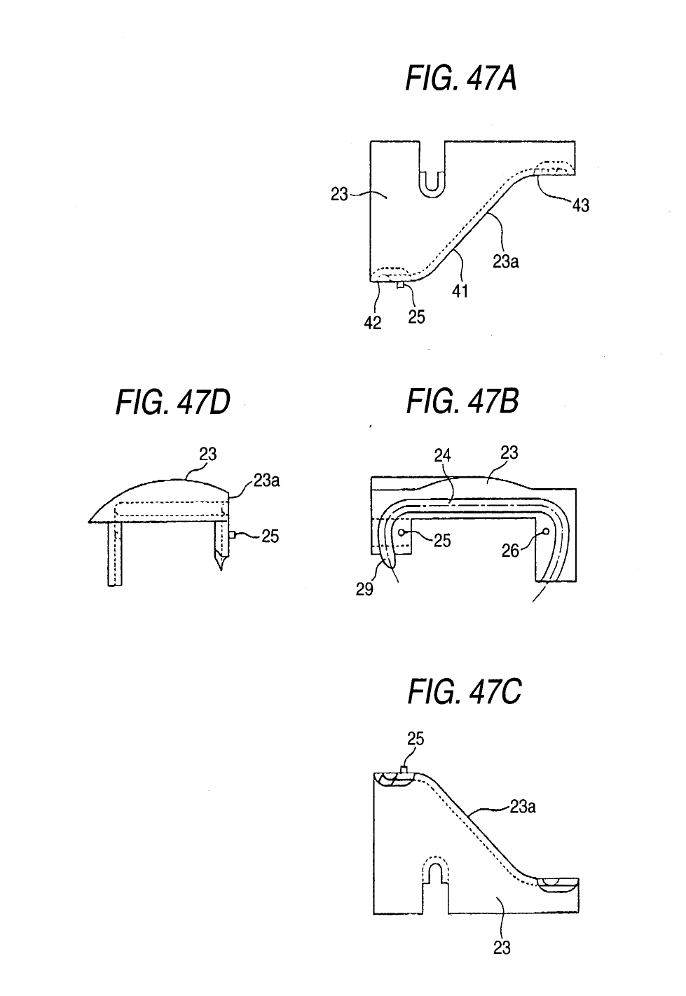

The present invention is not limited to the present embodiment. For example, in the eighth embodiment, the boundary between the first plane part 41 and the second plane part 42 is chamfered in order to prevent occurrence of a step in the boundary between the first and second plane parts 41, 42, both belonging to the mating surface 23a, which would otherwise be caused when ball return path 22 is formed in agreement with the groove part 24 formed in the mating surface 23a of the side-cap-constituting member 23. For example, as shown in FIG. 45, a surface 49 formed from a difference in level between the first plane part 41 and the second plane part 42 maybe inclined. Alternatively, as shown in FIG. 46, the surface 49 maybe curved, to thereby render the boundary between the first and second plane parts 41, 42 smooth and prevent occurrence of a step therebetween. Alternatively, in place of the side-cap-constituting members 23 which are joined together through use of the three plane parts 41, 42, and 43 shown in FIGS. 39 through 41, the side-cap-constituting members 23 shown in FIGS. 47A to 47D may be used as the pair of side-cap-constituting members constituting the side cap 17. Specifically, the side-cap-constituting members 23 have a construction such that the ball return path 22 is curved and such that the side-cap-constituting members 23 are joined together by means of single curved surfaces. In this way, the side-cap-constituting members not having a step may be used. At this time, the curved surface may preferably assume a gentle curvature such that the balls 15 roll smoothly.

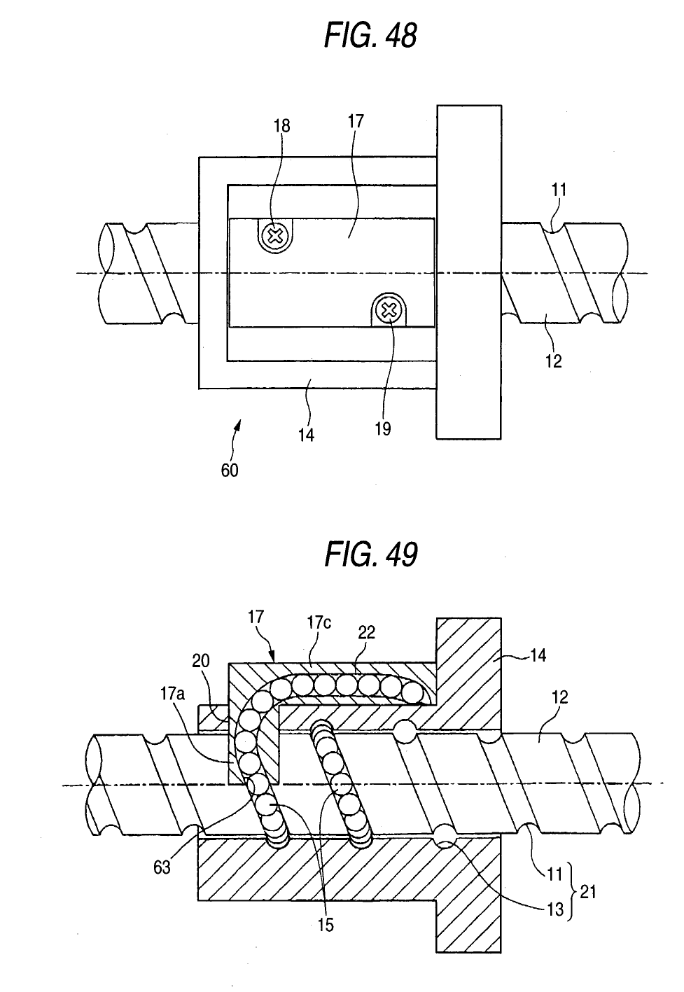

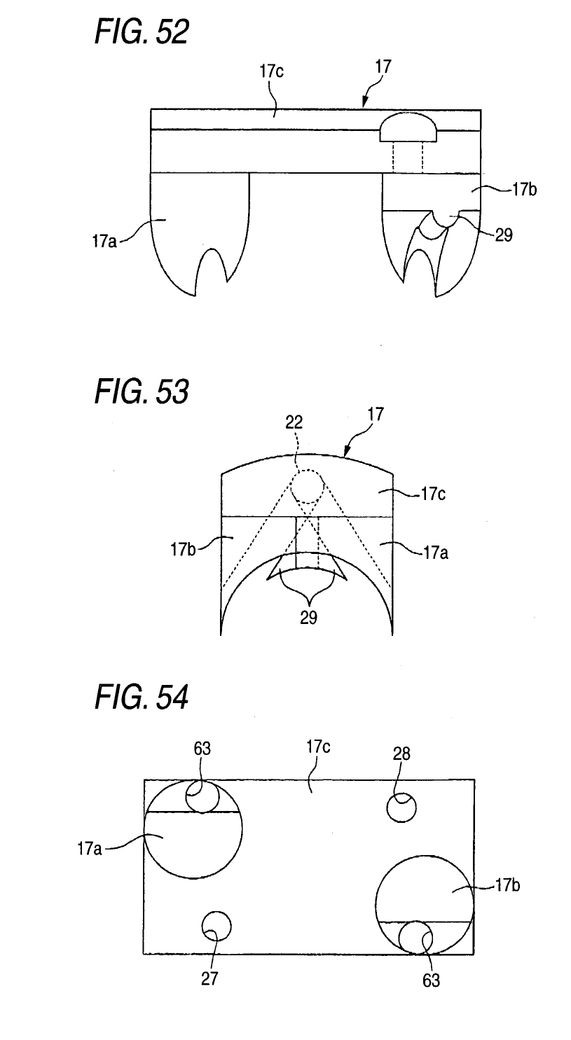

FIGS. 48 through 56 show a twelfth embodiment of the present invention. As shown in FIG. 48, a ball screw 60 of the twelfth embodiment comprises the screw shaft 12; the nut 14 which axially moves relative to the screw shaft 12 in association with rotation of the screw shaft 12; the plurality of balls 15 rotatably incorporated between the screw shaft 12 and the nut 14 (see FIG. 49); and the side cap 17 serving as a ball circulation member for circulating the balls 15.

A cross part of the screw shaft 12 taken along a direction perpendicular to the axial direction assumes a circular profile. The helical ball thread groove 11 is formed in the outer peripheral surface of the screw shaft 12. The ball thread groove 11 opposes the ball thread groove 13 formed in the inner peripheral surface of the nut 14 (see FIG. 49). When the screw shaft 12 or the nut 14 is rotated axially, the plurality of balls 15 interposed between the ball thread grooves 11, 13 roll over a helical ball loaded rolling groove defined between the ball thread grooves 11, 13 (see FIG. 49).

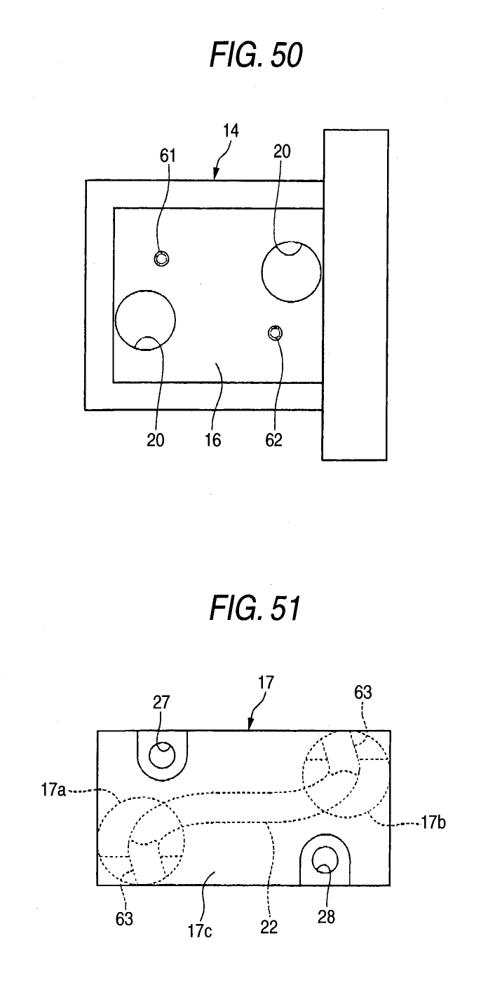

The side cap mount surface 16 is formed in the outer peripheral surface of the nut 14 (see FIG. 50). Screw holes 61, 62 through which the lock screws 18, 19 (see FIG. 48) for fastening a side cap are formed in the side cap mount surface 16. The ball circulation holes 20, 20 for circulating the balls 15 are also formed in the side cap mount surface 16.

The side cap 17 is formed from molding material; e.g., resin or metal, into a predetermined shape, by means of injection molding. The side cap 17 is formed from the pair of columnar ball scooping parts 17a, 17b to be fitted into the ball circulation holes 20, 20 (see FIGS. 51 through 53); and the plate-like side cap main body part 17c which has therein the ball return path 22 remaining in communication with ball return guide paths 63, 63 formed in the respective columnar ball scooping parts 17a, 17b.

As shown in FIGS. 51 and 53, the ball scooping parts 17a, 17b are formed so as to assume a circular cross-sectional profile. Therefore, the ball circulation holes 20, 20 into which the ball scooping parts 17a, 17 are fitted also assume circular cross-sectional profiles. As shown in FIG. 49, the balls 15 rolling over the ball loaded rolling groove 21 are scooped up by the tongue part 29 of the ball scooping part 17a or 17b, in the direction of the lead angles of the ball thread grooves 11, 13 and introduced into the ball return path 22.

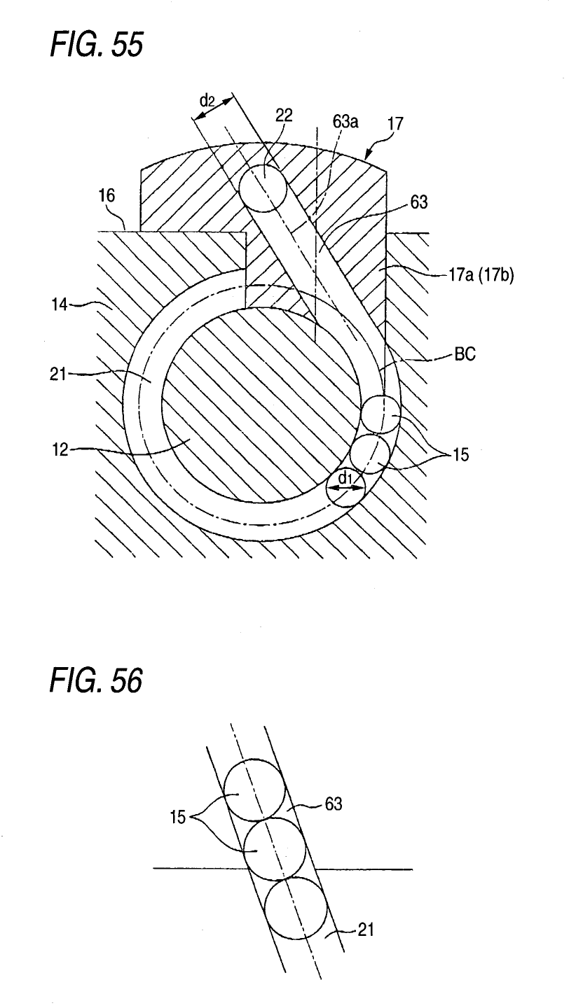

FIG. 55 is a cross-sectional view showing a part of the ball screw 60. As illustrated, the ball 15 assumes a diameter d₁, and the ball return guide path 63 assumes an inner diameter d₂ of about 1.01d₁ to 1.3 d₁. The ball return guide path 63 is formed between the ball scooping parts 17a, 17b while a center line 63a of the ball return guide path 63 is positioned within the centroid circle BC of the balls 15 and inclined to a direction of tangential adjusting of the centroid circle BC at the boundary between the ball loaded rolling groove 21 and the ball return guide path 63.

The side cap main body 17c has the side cap mount holes 27, 28 (see FIG. 51). The lock screws 18, 19 are inserted into the side cap mount holes 27, 28.

As mentioned above, when the ball scooping parts 17a, 17b are formed so as to assume a circular cross-sectional profile, the ball circulation hole 20 also assumes a circular cross-sectional profile. As compared with the case where the ball scooping parts 17a, 17b are formed to assume a rectangular cross-sectional, the number of operations required to drill the ball circulation hole 20 is reduced, thereby enabling cost cutting.

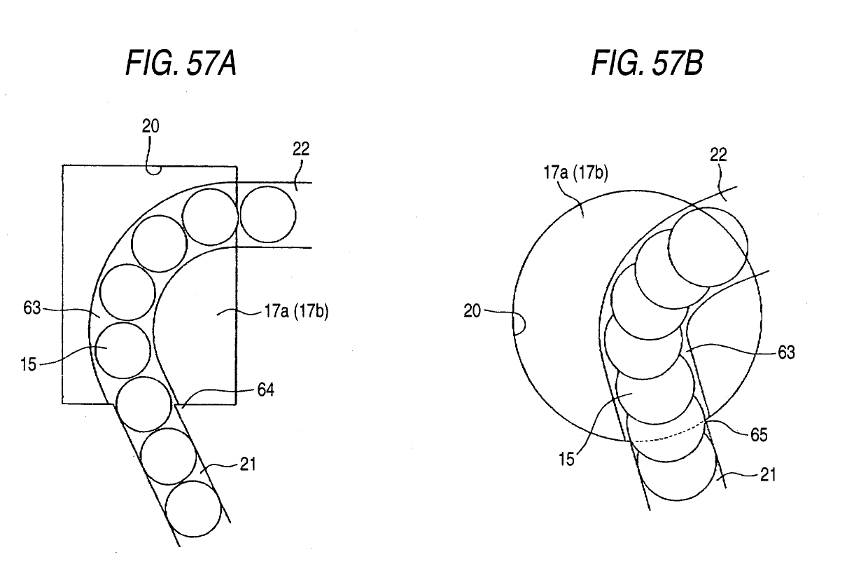

As shown in FIG. 57A, when the ball scooping parts 17a, 17b assume a rectangular cross-sectional profile, an acute step part 64 arises in the boundary between the ball loaded rolling groove 21 and the ball return guide path 63. Damage may be inflicted on the balls 15 as a result of the balls 15 colliding with the step part 64. However, as in the case of the previous embodiment, if the ball scooping parts 17a, 17b are formed so as to assume a circular cross-sectional profile, an obtuse step part 65 arises in the boundary between the ball loaded rolling groove 21 and the ball return guide path 63. Hence, infliction of damage to the balls 15 can be prevented.

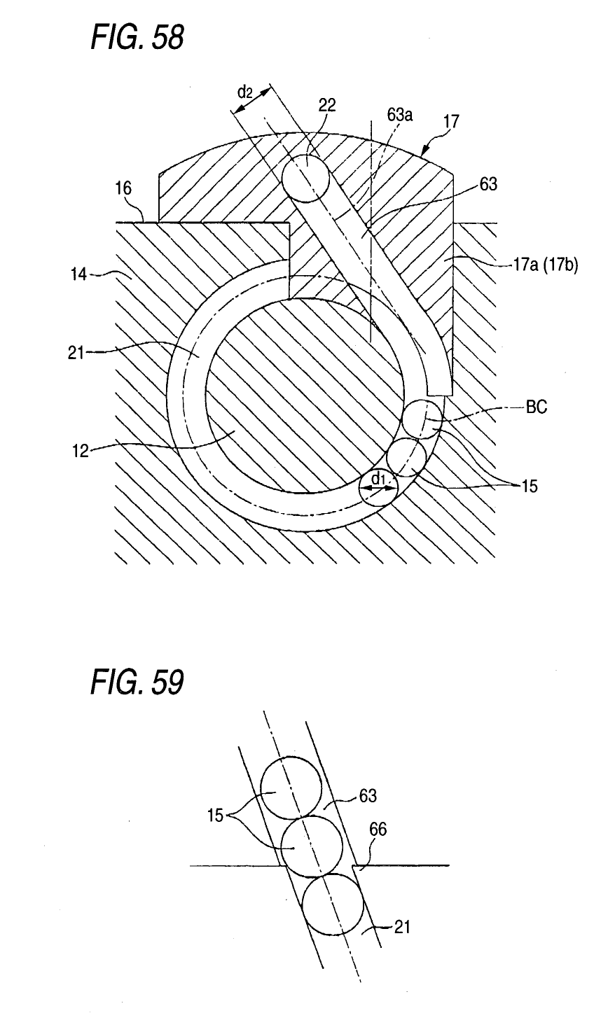

As shown in FIG. 58, if the ball return guide path 63 is formed within the ball scooping parts 17a, 17b such that the center line 63a of the ball return guide path 63 is located outside the centroid circle BC of the balls 15 at the boundary between the ball loaded rolling groove 21 and the ball return guide path 63, a step 66 which would inflict damage on the balls 15 arises in the boundary between the ball loaded rolling groove 21 and the ball return path 63 (see FIG. 59), because the inner diameter d₂ of the ball return guide path 63 assumes about 1.01d₁ to 1.3d₁ in terms of the diameter d₁ of the ball 15. However, if the ball return guide path 63 is formed in the ball scooping parts 17a, 17b such that the center line 63a of the ball return guide path 63 is located within the centroid circle BC of the balls 15 at the boundary between the ball loaded rolling groove 21 and the ball return guide path 63, as shown in FIG. 56 the step 66 does not arise in the boundary between the ball loaded rolling groove 21 and the ball return path 63, thereby preventing infliction of damage to the balls 15.

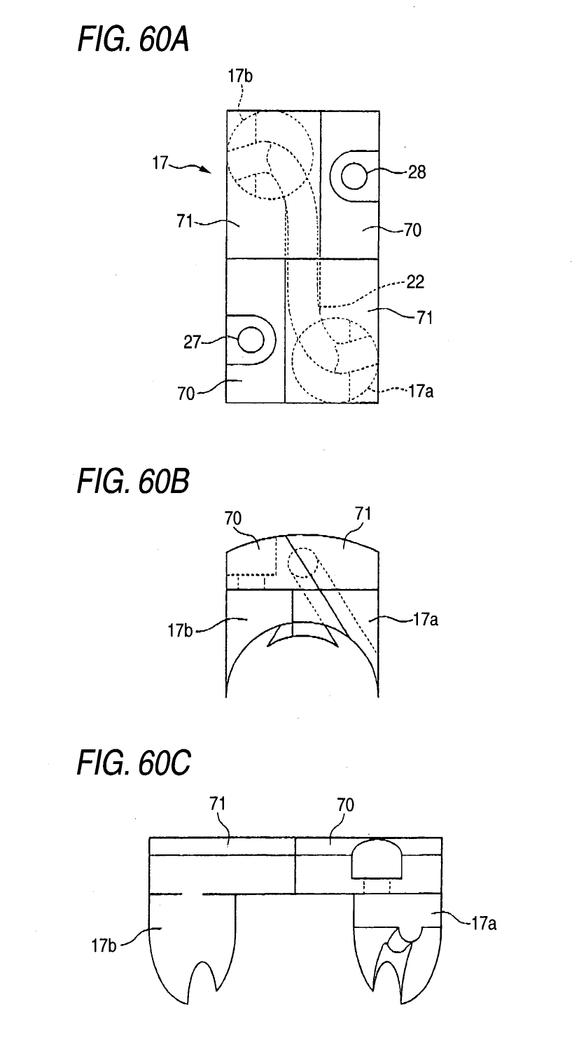

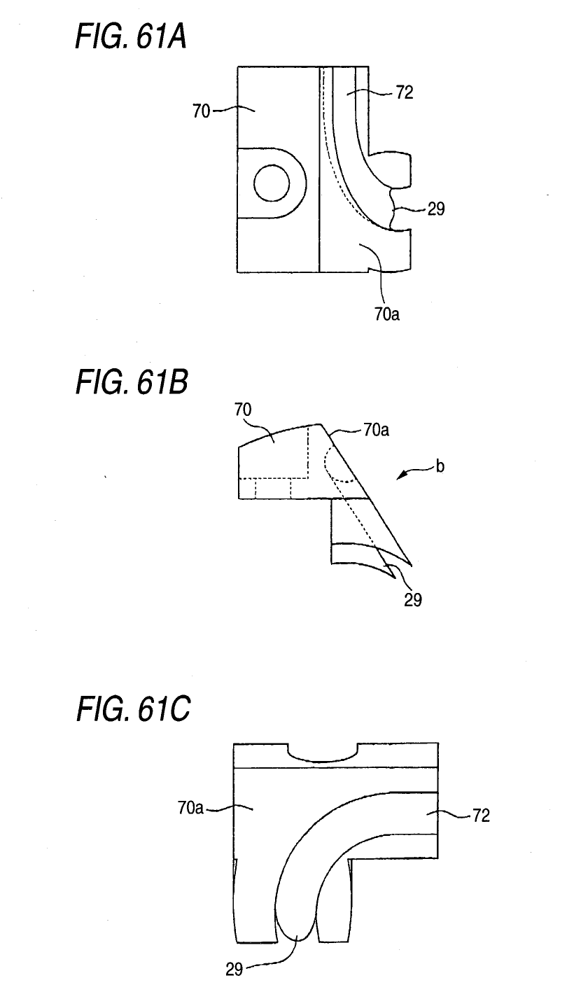

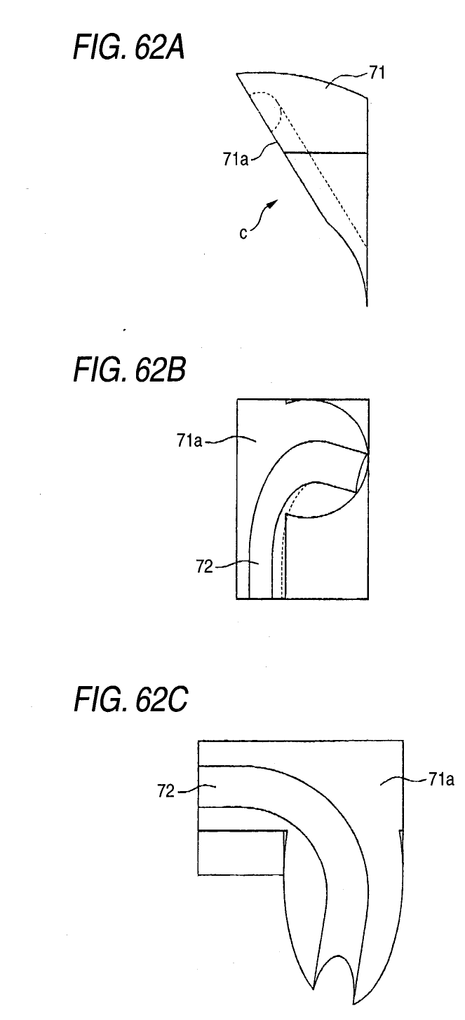

FIGS. 60A to 62C are views showing a thirteenth embodiment of the present invention. As illustrated, the side cap 17 is constituted of two pairs of members, each pair consisting of side-cap-constituting members 70, 71. The side-cap-constituting members 70, 71 have butting surfaces 70a, 71a, respectively. Groove parts 72 to be used for forming the ball return guide path 63 and the ball return path 22 are formed in the respective butting surfaces 70a, 71a. The side-cap-constituting members 70, 71 are formed from, e.g., resin material, in a predetermined form, by means of injection molding.

By means of such a construction, the side cap 17 is assembled during assembly of a ball screw by causing the butting surface 70a of the side-cap-constituting member 70 and the butting surface 71a of the side-cap-constituting member 71 to butt against each other. As a result, the ball return path 22 is formed in the side cap 17. Hence, machining costs incurred in formation of the ball return path 22 can be curtailed.

This embodiment has illustrated an example in which the side cap 17 is divided into four parts. However, the side cap 17 may be divided into two parts. Further, although in the present embodiment the side-cap-constituting members 70, 71 are formed from resin, metal may be employed in lieu of resin. In this case, the side cap 17 can be inexpensively mass-produced through casting, sintering metallurgy, or metal injection molding (MIM).

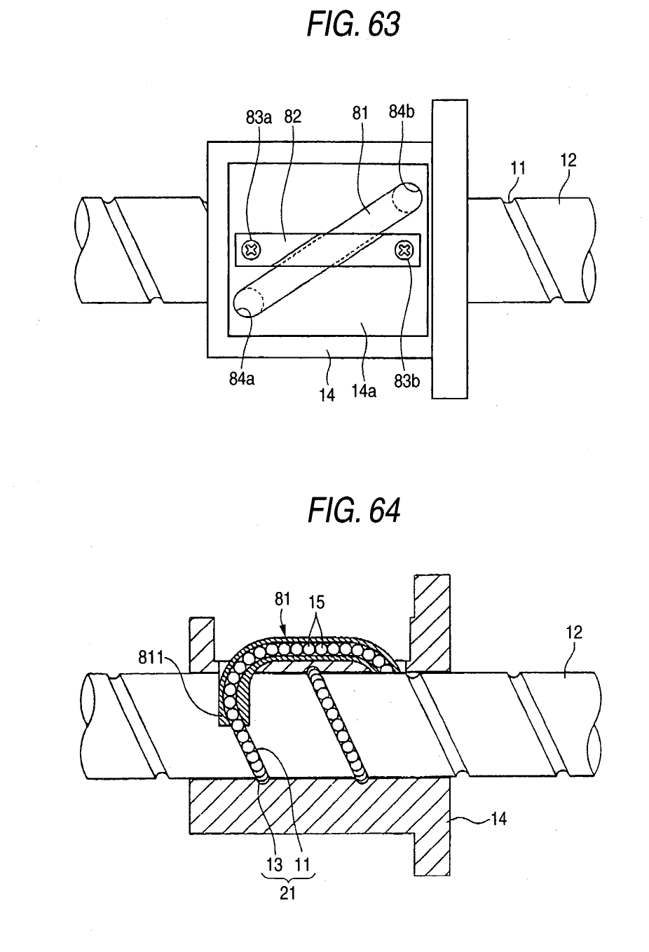

A fourteenth embodiment of the present invention will now be described by reference to FIGS. 63 through 68.

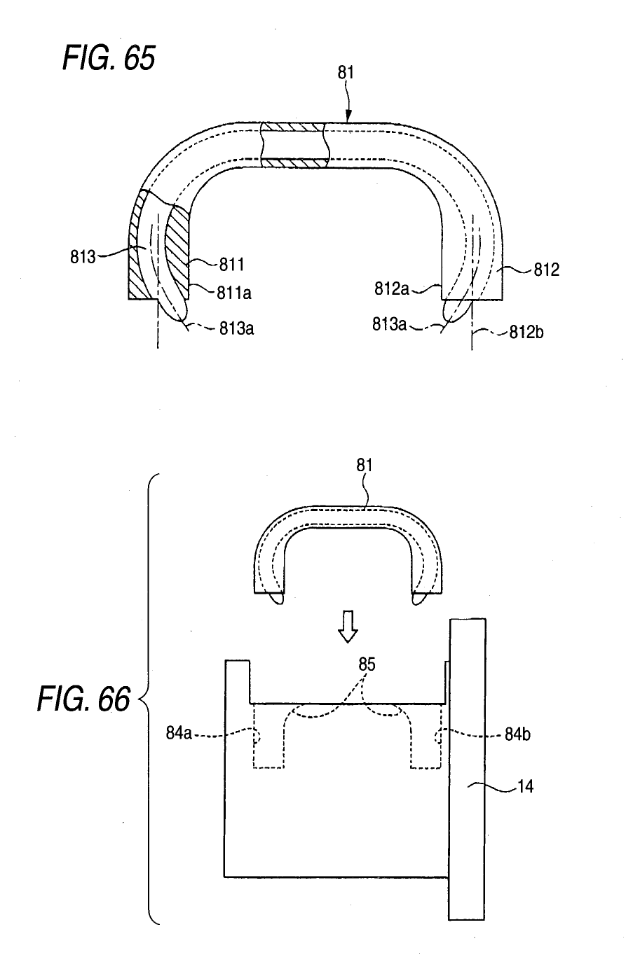

FIG. 63 is a side view of a ball screw according to a fourteenth embodiment of the present invention. FIG. 64 is a cross-sectional view of the ball screw of this embodiment taken along the axial direction of the ball screw. As illustrated, the ball screw of the embodiment comprises the screw shaft 12; the nut 14, on whose inner periphery of which the helical ball thread groove 13 is formed so as to oppose the helical ball thread groove 11 formed in the outer peripheral surface of the screw shaft 12 (see FIG. 64); the plurality of balls 15 which roll over the ball loaded rolling groove 21 defined between the ball thread grooves 11, 13 in association with rotation of the screw shaft 12 or the nut 14; and a ball circulation member 81 having therein a ball return path 813 (see FIG. 65) for circulating the balls 15 outside the nut 14.

The ball circulation member 81 is formed from resin or metal by injection molding or is formed from metal by means of sintering. The ball circulation member 81 is fastened to a plane part 14a formed in the outer peripheral surface of the nut 14, through use of pressing hardware 82 and lock-screws 83a, 83b. As shown in FIG. 65, the ball circulation member 81 has two ball scooping parts 811, 812. The ball scooping part 811 is fitted into a ball scooping hole 84a formed in the plane part 14a of the nut 14, and the ball scooping part 812 is fitted into a ball return hole 84b formed in the plane part 14a of the nut 14 (see FIG. 63). The ball circulation member 81 extends from the ball scooping part 811 (or 812) to the other ball scooping part 812 (or 811). As shown in FIG. 65, a center axis line 813a of a ball return path 813 formed in the ball scooping parts 811, 812 is parallel to neither a peripheral surface 811a of the ball scooping part 811 nor a peripheral surface 812a of the ball scooping part 812. In other words, the center axis line 813a of the ball return path 813 is parallel to neither a center axis line 811b of the ball scooping part 811 nor a center axis line 812b of the ball scooping part 812.

The ball scooping hole 84a and the ball return hole 84b are formed perpendicular to the axial direction of the nut 14. A recess 85 is formed in the ball scooping hole 84a and the ball return hole 84b, to thereby prevent occurrence of interference with the ball circulation member 81 (see FIG. 66).

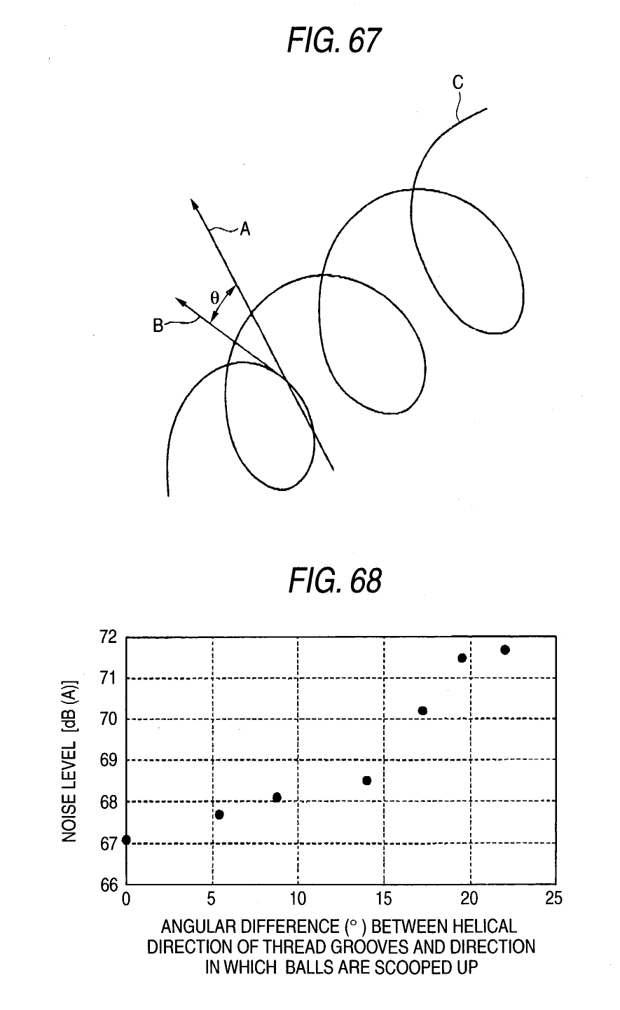

FIG. 67 is a view schematically showing a direction in which the balls 15 are to be scooped by the ball scooping part 811 (or 812) of the ball circulation member 81. As illustrated, the direction in which the balls 15 are to be scooped by the ball scooping part 811 or 812 (denoted by the direction of the arrow A) forms an angular difference θ of 15° or less with respect to the helical direction (denoted by the direction of the arrow B) of the ball thread grooves 11, 13, at a point P at which the balls 15 are to be scooped. Reference symbol C provided in the drawing denotes a centroid circle of the ball 15 rolling through the ball thread grooves 11, 13.

In the ball screw having such a construction, the balls 15 rolling over the ball loaded rolling groove 21 are scooped up in the helical direction of the ball thread grooves 11, 13 (i.e., a direction into which the directions of lead angles of the ball thread grooves 11, 13 and a tangential direction of the centroid circle of the balls 15 are merged) in association with rotation of the screw shaft 12 or the nut 14, by means of the ball scooping part 811 or 812 of the ball circulation member 81. Therefore, unlike the case of a related-art ball screw of tube type which scoops the balls rolling over the ball loaded rolling groove in the direction perpendicular to the screw shaft, the balls rolling over the ball loaded rolling groove can be circulated without colliding with the tongue parts of the ball circulation member. Accordingly, occurrence of vibration or noise can be inhibited. Unlike the case of a ball screw of end cap type, the number of ball circulation circuits is not limited to the number of thread grooves. Hence, load capacity of the ball screw can be increased without involvement of an increase in the number of balls per circuit.

Unlike the case of the ball screw described in JP-UM-A-59-39352, there is no necessity for machining the ball scooping hole and the ball return hole so as to be inclined in the direction of lead angles of the ball thread grooves. Hence, balls can be circulated outside a nut without involvement of a cost rise. Further, unlike the case of the ball screw described in JP-A-2000-18359, large clearance does not arise between the nut and the ball circulation tube. Hence, balls can be circulated outside a nut without involvement of leakage of lubricating oil or intrusion of extraneous matter.

According to the embodiment, the direction in which the balls 15 are scooped up by the ball scooping part 811 or 812 forms an angular difference of 15° or less with respect to the helical direction of the ball thread groove 11. Therefore, as shown in FIG. 68, the noise caused during operation can be made lower than that arising in the ball screw, wherein the direction in which the balls 15 are to be scooped up forms an angular difference of 20° or more with respect to the helical direction of the ball thread grooves 11, 13.

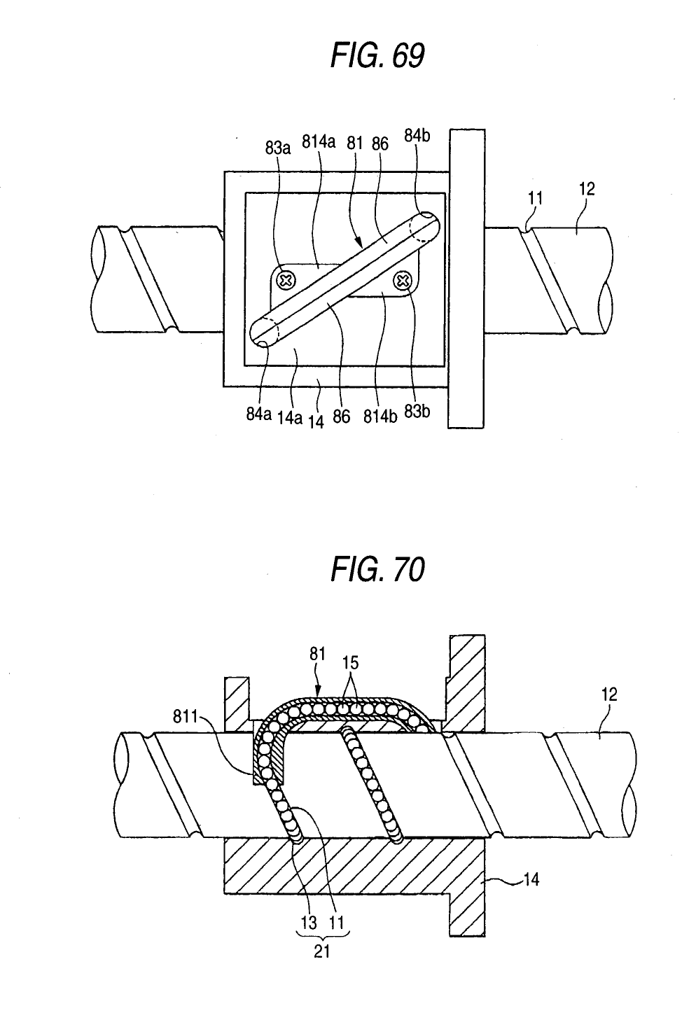

A fifteenth embodiment of the present invention will now be described by reference to FIGS. 69 through 73.

FIG. 69 is a plan view of a ball screw according to a fifteenth embodiment of the present invention; and FIG. 70 is a cross-sectional view of the ball screw of the embodiment taken along an axial direction of the ball screw. As illustrated, the ball screw of the embodiment comprises the screw shaft 12; the nut 14, on whose inner periphery the helical ball thread groove 13 is formed so as to oppose the helical ball thread groove 11 formed in the outer peripheral surface of the screw shaft 12 (see FIG. 70); the plurality of balls 15 which roll over the ball loaded rolling groove 21 defined between the ball thread grooves 11, 13 in association with rotation of the screw shaft 12 or the nut 14; and the ball circulation member 81 for circulating the balls 15 outside the nut 14.

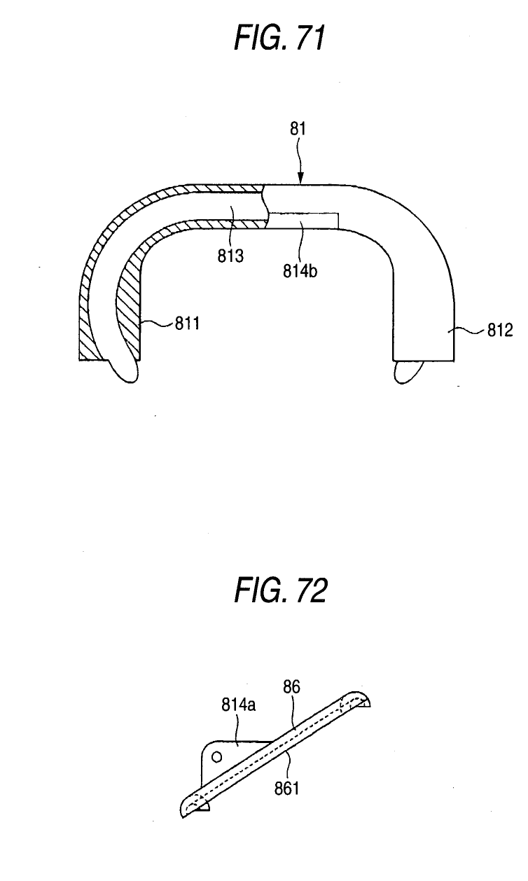

The ball circulation member 81 has plate-like pressing parts 814a, 814b. The pressing part 814a is fastened to the plane part 14a formed in the outer peripheral surface of the nut 14, by means of a lock-screw 83a, and the pressing part 814b is fastened to the same part by means of a lock-screw 83b. As shown in FIG. 71, the ball circulation member 81 has the two ball scooping parts 811, 812. The ball scooping part 811 is fitted into the ball scooping hole 84a formed in the plane part 14a of the nut 14, and the ball scooping part 812 is fitted into the ball return hole 84b formed in the plane part 14a of the nut 14 (see FIG. 69). The ball circulation member 81 has therein the ball return path 813, and the ball return path 813 is divided in the traveling direction of the balls 15, by means of two circulation-part-constituting members 86, 86 (see FIG. 69) constituting the ball circulation member 81.

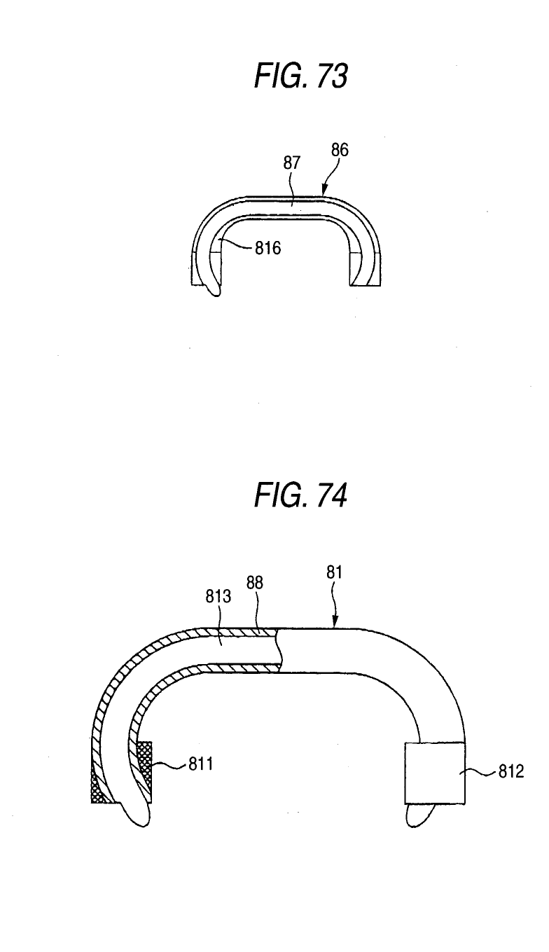

The circulation part constituting members 86 are formed from resin or metal into a predetermined shape by means of injection molding. As shown in FIGS. 72 and 73, the circulation-part-constituting members 86 have mating surfaces 861, respectively. Groove parts 87 to be used for forming a ball return path 813 are formed in the respective mating surfaces 861.

In the ball screw having such a construction, the balls 15 rolling over the ball loaded rolling groove 21 are scooped up in the helical direction of the ball thread grooves 11, 13, by means of the ball scooping part 811 or 812 of the ball circulation member 81. Therefore, unlike the case of the related-art ball screw of tube type which scoops the balls rolling over the ball loaded rolling groove in the direction perpendicular to the screw shaft, the balls rolling over the ball loaded rolling groove can be circulated without colliding with the tongue parts of the ball circulation member. Accordingly, occurrence of vibration or noise can be inhibited. Unlike the case of the ball screw of end cap type, the number of ball circulation circuits is not limited to the number of thread grooves. Hence, load capacity of the ball screw can be increased without involvement of an increase in the number of balls per circuit.

Unlike the case of the ball screw described in JP-UM-A-59-39352, there is no necessity for machining the ball scooping hole and the ball return hole so as to be inclined in the direction of lead angles of the ball thread grooves. Hence, balls can be circulated outside a nut without involvement of a cost rise. Further, unlike the case of the ball screw described in JP-A-2000-18359, large clearance does not arise between the nut and the ball circulation tube. Hence, balls can be circulated outside a nut without involvement of leakage of lubricating oil or intrusion of extraneous matter.

In the embodiment, the ball return path 813 is divided along the rolling direction of the balls 15 by means of the two circulation-part-constituting members 86 constituting the ball circulation member 81. The ball return path 813 can be easily formed in the ball circulation member 81. As a result, machining costs incurred in formation of the ball return path 813 can be curtailed.

In the embodiment, the pressing members 814a, 814b are formed integrally in the ball circulation member 81. Hence, the pressing hardware 82, such as that shown in FIG. 63, becomes obviated, thereby enabling a reduction in the number of parts.

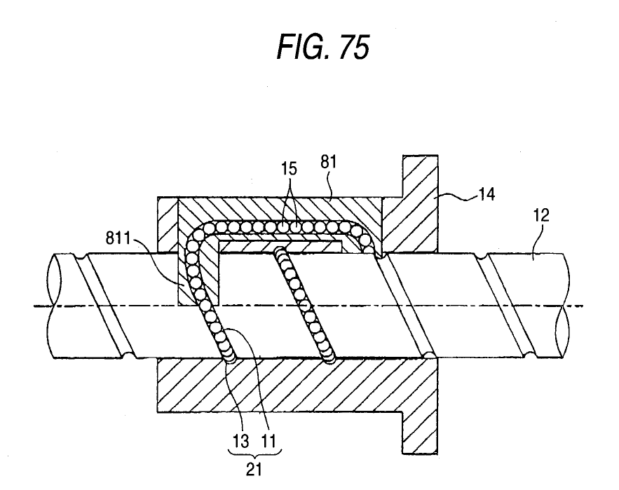

In the fourteenth and fifteenth embodiments, the ball scooping parts 811, 812 of the ball circulation member 81 are formed integrally with the ball circulation member 81. However, as in the case of a sixteenth embodiment shown in FIG. 74, the ball circulation member 81 may be formed from a tubular member 88, and the ball scooping parts 811, 812 maybe formed by buildup welding of both ends of the tubular member 88. Moreover, the recess 85 are provided in the nut 14 for preventing occurrence of interference with the ball circulation member 81 in the fourteenth embodiment. However, as shown in FIG. 75, the nut 14 may be employed without having a recess.

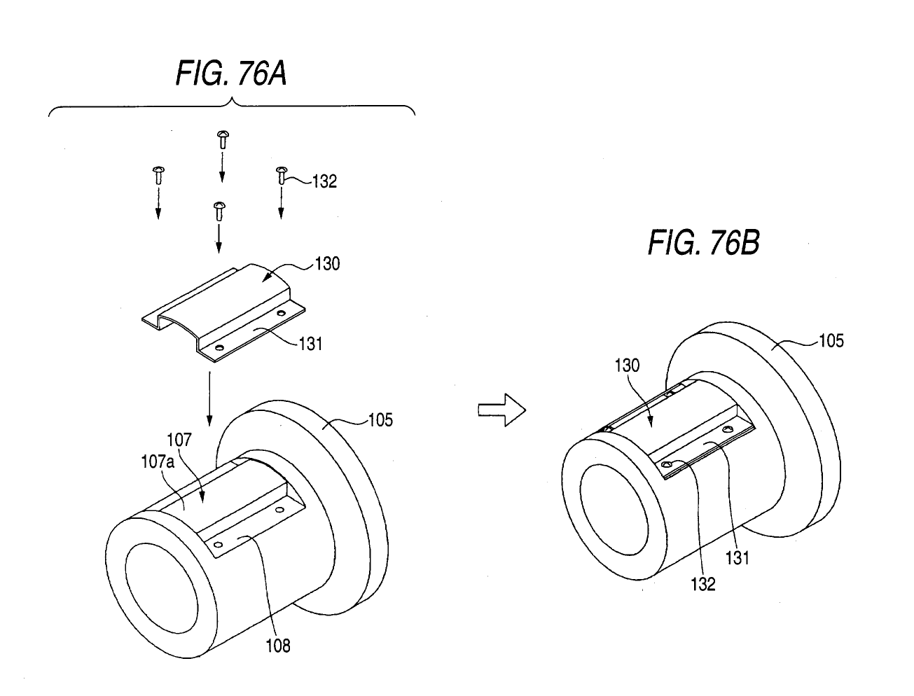

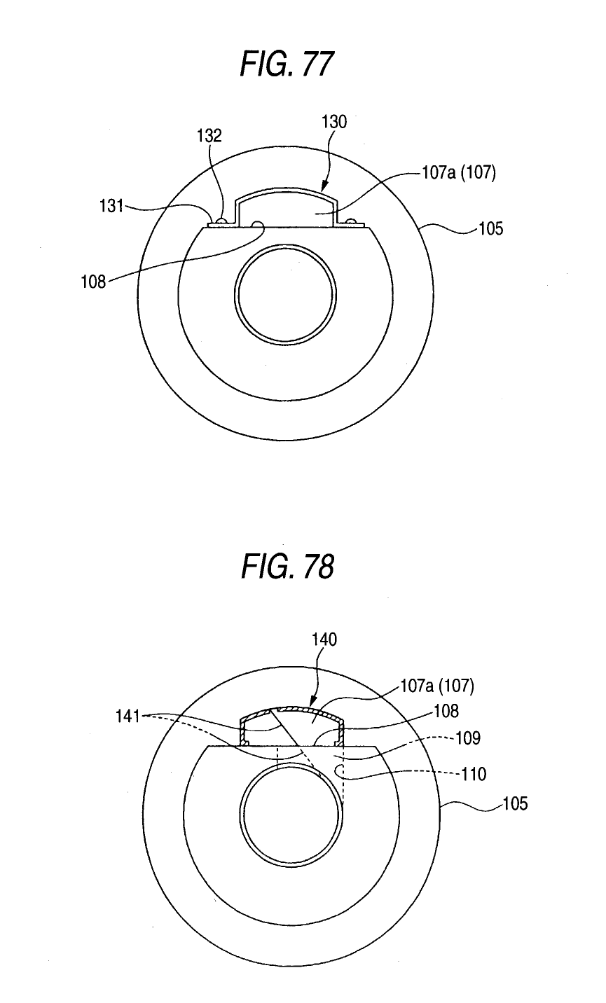

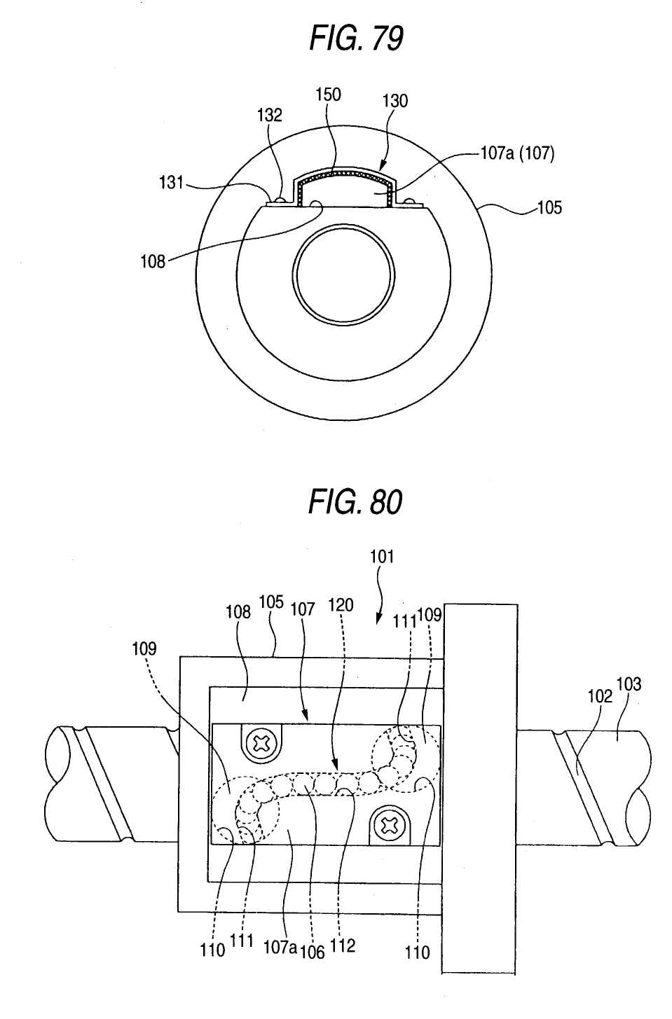

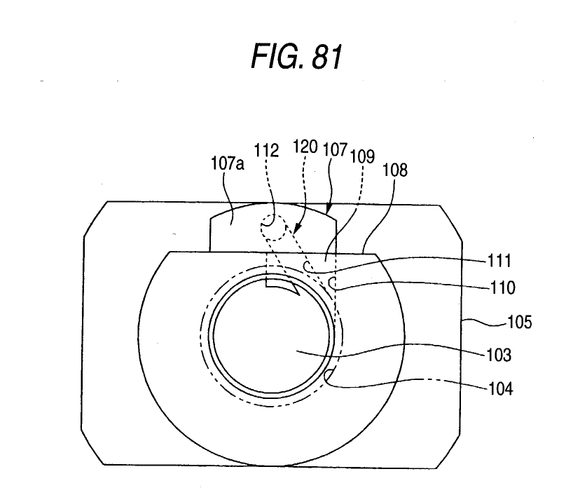

FIGS. 76A and 76B are drawings showing a nut of a ball screw of side cap type which is a sixteen embodiment of the present invention. FIG. 76A is an exploded perspective view showing a sound insulation member before it is attached to a side cap, and FIG. 76B is a perspective view showing the sound insulation member after it has been attached to the side cap. FIG. 77 is a view of a nut when viewed from an axial end part thereof while the sound insulation member is attached to the side cap. FIGS. 78 and 79 are views of a nut belonging to a ball screw of side cap type according to other embodiments of the present invention when viewed from an axial end part of the nut. The essential configuration of the ball screw of side cap type is substantially identical with that described in connection with FIGS. 80 and 81. Hence, those reference numerals which are the same as those shown in FIGS. 80 and 81 denote the same elements, and only differences between the conventional ball screw and the embodiments are described.

As shown in FIGS. 76A and 76B, in the ball screw of side cap type which is an embodiment of the present invention, a cap main body 107a of a side cap 107 attached to a mount surface 108 of a nut 105 is covered with a plate-like sound insulation member 130.

The sound insulation member 130 has a cross-sectional profile corresponding to the outer shape of the cap main body 107a. Mount flanges 131 are provided on either side of the sound insulation member 130 located in the transverse direction thereof. As shown in FIGS. 76B and 77, the sound insulation member 130 is secured on the mount surface 108 while covering the cap main body 107a, by means of attaching the mount flanges 131 to the mount surface 108 with fixing means, such as screws 132.

Preferably, the sound insulation member 130 is formed from material which is higher in density than the material of the side cap 107. For example, when the side cap 107 is formed from lightweight resin, the sound insulation member 130 is preferably formed from a metal plate such as iron or lead or from rubber or the like whose density is increased by mixing metal powder therein.

According to the embodiment, the plate-like sound insulation member 130 covers the cap main body 107a of the side cap 107 attached to the mount surface 108 of the nut 105. Hence, escape of noise developing in the nut 105 to the outside by propagating through the side cap 107 can be prevented, thereby diminishing noise.

Although not shown in FIGS. 76A and 76B, if the side cap 107 is split along a ball circulation path 120 for facilitating formation of the ball circulation path 120 in the side cap 107 and the thus-split side cap members are subsequently joined, leakage of noise developing in the nut 105 by way of clearance existing in the joint can be prevented by the sound insulation member 130.

The construction of the ball screw of side cap according to the present invention; particularly, the construction of the side cap and that of the sound insulation member, is not limited to that mentioned in the embodiment. The construction is susceptible to modifications falling within the scope of the present invention.

The embodiment has described the present invention by reference to a case where the cap main body 107a of the side cap 107 is covered with the sound insulation member 130. However, as shown in FIG. 78, instead of the sound insulation member 130, a sound insulation member 140 may be formed in the cap main body 107a by means of insert molding. This construction enables a reduction in the noise that escapes by propagating through the side cap 107, without involvement of an increase in the number of components. Particularly, when the side cap 107 is split along the ball circulation path 120 for facilitating formation of the ball circulation path 120 in the side cap 107 and the thus-split side cap members are subsequently joined (as indicated by 141 in FIG. 78), the sound insulation member 140 can be made effective.

In this case, the side cap 107 may be split into two or more sub-divisions. Further, pieces into which the sound insulation member 140 is split are preferably molded into the respective sub-divisions of the side cap 107 by means of insert molding. Preferably, the sound insulation member 140 is formed from material suitable for insert molding, such as a metal plate.

The embodiment has described the present invention by reference to a case where the cap main body 107a of the side cap 107 is covered directly with the sound insulation member 130. However, this is not necessarily required. As shown in FIG. 79, a sound absorbing member 150 may be interposed between the sound insulation member 130 and the cap main body 107a. By means of this construction, the noise developing in the nut 105 is absorbed by the sound absorbing member 150 after having propagated through the side cap 107. The noise that has propagated through the sound absorbing member 150 is insulated by the sound insulation part 130. For this reason, the noise that escapes outward by propagating through the side cap 107 can be significantly diminished. The sound absorbing member 150 can be formed from glass wool, steel wool, or sound absorbing rubber.

As has been described, the ball screw according to the present invention defined in the first aspect prevents infliction of damage to balls or occurrence of noise, which would otherwise be caused when balls are scooped up. Moreover, load capacity can be increased without involvement of an increase in the number of balls per circuit.

In addition to yielding the advantages set forth, the ball screw according to the present invention of the second aspect yields an advantage of the ability to easily form, in the side cap, a ball return path which scoops balls up in a direction matching lead angles of ball thread grooves and returning the balls to the initial position.

In the ball screw according to the present invention of the third aspect, a side cap can be formed through use of a single mold. Hence, in addition to yielding the advantages set forth, the ball screw yields an advantage of the ability to inexpensively manufacture the side cap.

In addition to yielding the advantages set forth, the ball screw according to the present invention of the fourth aspect yields an advantage of the ability to inexpensively mass-produce a side cap by means of injection molding.

In addition to yielding the advantages set forth, the ball screw according to the present invention of the fifth aspect yields an advantage of the ability to sustain rotational balance in a nut when the ball screw is formed as a nut rotation type. Further, the ball screw can be used under high temperature conditions that are unsuitable for use of resin.

In addition to yielding the advantages set forth, the ball screw according to the present invention of the sixth aspect yields an advantage of the ability to prevent direct transmission to the nut, as excitation force, of the collision force exerted on the side cap by the balls. Therefore, occurrence of noise or vibration, which would otherwise be caused when the balls exert the collision force on the side cap, can be prevented.

In the ball screw according to the present invention of the seventh aspect, when the balls are clogged in the ball return path in the side cap, the length of the ball return path is extended by the pushing force developing among the balls. Therefore, in addition to yielding the advantages set forth, the ball screw yields an advantage of the ability to improve the operability of the ball screw and prevent infliction of damage to the balls, which would otherwise be caused by collision between the balls.

In the ball screw according to the present invention of the eight aspect, the necessity for forming, in the nut, mount holes required to fasten the side cap to the nut with screws is eliminated. Consequently, costs incurred in machining the mount holes can be curtailed, and the pressing force exerted on the side cap by the balls can be released. In addition to yielding the advantages set forth, the ball screw yields an advantage of the ability to diminish collision force developing among the balls, thereby improving the operability of the ball screw and preventing infliction of damage to the balls.

The ball screw according to the present invention of the ninth aspect eliminates a worry about axial displacement of the elastic pressing member, which may in turn cause dislodgment of the side cap.

In the ball screw according to the present invention of the tenth aspect, the number of active coils of the ball thread grooves to be formed in the inner peripheral surface of the nut becomes close to an integer. Hence, in addition to yielding the advantages set forth, the ball screw yields an advantage of the ability to increase the load capacity of the ball screw.

In the ball screw according to the present invention of the eleventh aspect, collision of the balls against the ball scooping parts can be mitigated. Hence, in addition to yielding the advantages set forth, the ball screw yields an advantage of the ability to prevent occurrence of noise or vibration.

In the ball screw according to the present invention of the twelfth aspect, collision of the balls against the ball scooping parts can be mitigated. Hence, in addition to yielding the advantages set forth, the ball screw yields an advantage of the ability to prevent occurrence of noise or vibration.

In the ball screw according to the present invention of the thirteenth aspect, the number of active coils is increased and becomes close to an integer. Consequently, in addition to yielding the previously-described advantages, the ball screw yields an advantage of the ability to increase the load capacity of the ball screw, thereby diminishing axial imbalance in rigidity.

In addition to yielding the previously-described advantages, the ball screw according to the present invention of the fourteenth aspect yields an advantage of the ability to prevent collision of balls against a step, which would otherwise arise in a boundary between mating surfaces when the ball return path is formed by combination of a pair of side cap constituting members.

In the ball screw according to the present invention of the fifteenth aspect, no step arises in mating surfaces when the ball return path is formed by combination of a pair of side-cap-constituting members. Hence, in addition to yielding the previously-described advantages, the ball screw yields an advantage of the ability to prevent collision of the balls.

In the ball screw according to the present invention of the sixteenth aspect, the ball scooping parts are formed so as to assume a circular cross-sectional profile. As a result, the number of operations required to drill the ball circulation hole is reduced, thereby enabling cost cutting. A step part arising in the boundary between a ball loaded rolling groove and a ball return guide path becomes obtuse. Hence, infliction of damage to the balls can be prevented.

In the ball screw according to the present invention of the eighteenth aspect, no step part arises in the boundary between the ball loaded rolling groove and the ball return guide path. Hence, infliction of damage to the balls can be prevented.

The ball screw according to the present invention of the nineteenth aspect prevents infliction of damage to balls or occurrence of noise, which would otherwise be caused when balls are scooped up, and enables an increase in load capacity without involvement of an increase in the number of balls per circuit.

In addition to yielding the advantages yielded by the present invention of the nineteenth aspect, the ball screws according to the present inventions defined in the twentieth and twenty-first aspects yield an advantage of the ability to easily form a ball return path in the ball circulation member.

In addition to yielding the advantages yielded by the present invention of the twentieth aspect, the ball screws according to the present inventions defined in the twenty-second and twenty-third aspects yield an advantage of the ability to inexpensively manufacture the ball circulation member, thus curtailing costs.

In addition to the yielding advantages yielded by the present invention defined in anyone of the first to twenty-third aspects, the ball screw according to the present invention defined in the twenty-fourth aspect yields an advantage of the ability to circulate balls outside the nut while more effectively inhibiting occurrence of noise or vibration.

In addition to yielding the advantages yielded by the present invention of the nineteenth aspect, the ball screw according to the present invention defined in the twenty-fifth aspect yields an advantage of the ability to easily form the ball scooping parts by build-up welding of both ends of a tubular member constituting the ball circulation member.

As is obvious from the above descriptions, the present invention defined in the twenty-sixth aspect naturally yields an advantage of the ability to prevent damage to balls, which would otherwise be inflicted when the balls are scooped up, and an advantage of the ability to increase load capacity without involvement of an increase in the number of balls per circuit (an increase in the number of coils per circuit). Further, the present invention yields an advantage of the ability to diminish noise, which would otherwise escape to the outside from the inside of a nut, by means of insulation.

In addition to yielding the advantages yielded by the present invention defined in the twenty-sixth aspect, the present invention defined in the twenty-seventh aspect further yields an advantage of the ability to enhance a noise reduction effect by means of interposing a sound absorbing member between a side cap and a sound insulation member.

The present invention defined in the twenty-eighth aspect naturally yields an advantage of the ability to prevent damage to balls, which would otherwise be inflicted when the balls are scooped up, and an advantage of the ability to increase load capacity without involvement of an increase in the number of balls per circuit (an increase in the number of coils per circuit). Further, the present invention yields an advantage of the ability to diminish noise, which would otherwise escape to the outside from the inside of a nut, by means of insulation. In addition, the present invention enables a reduction in the number of components. Hence, when a side cap is split for facilitating formation of a ball circulation path in the side cap and the thus-split pieces of the side cap are subsequently joined, a sound insulation member can be made effective.

What is claimed is:

1. A ball screw comprising:
a screw shaft including a ball thread groove formed on an outer peripheral surface thereof;
a nut including a ball thread groove formed on an inner peripheral surface thereof, the inner peripheral surface being opposed to the outer peripheral surface of the screw shaft, and a side cap mount surface being formed in the outer peripheral surface of the nut;
a plurality of balls disposed between the thread groove of the nut and the thread groove of the screw shaft; and,
a side cap fastened to the side cap mount surface and including a ball scooping part and a ball return path for scooping up the balls from one side and returning the balls to another side.

2. The ball screw according to claim 1, wherein the ball return path formed in an inside of the side cap is divided into a plurality of pieces along a direction of movement of the balls.

3. The ball screw according to claim 2, wherein the side cap is formed by combining side-cap-constituting members having identical shapes each other symmetrically about a point.

4. The ball screw according to claim 1, wherein the side cap is formed from resin.

5. The ball screw according to claim 1, wherein the side cap is formed from sintered material.

6. The ball screw according to claim 1, wherein a cushioning member is interposed between a ball circulation hole formed in the nut and the ball scooping part inserted into the ball circulation hole.

7. The ball screw according to claim 1, wherein an elastic member is interposed between the side cap mount surface and the side cap.

8. The ball screw according to claim 1, wherein the side cap is pressed against the side cap mount surface by an elastic pressing member provided on the outer periphery of the nut.

9. The ball screw according to claim 8, wherein the elastic pressing member is at least partially housed in a groove part formed on an outer peripheral surface of at least one of the nut and the side cap.

10. The ball screw according to claim 1, wherein the ball return path comprises a linear part provided in a center of the side cap and in parallel with the screw shaft, and curved parts extending continuously from respective ends of the linear part.

11. The ball screw according to claim 1, wherein the ball scooping part scoops up the balls rolling between the ball thread grooves in a direction of lead angles of the ball thread grooves, to thereby guide the balls to the ball return path.

12. The ball screw according to claim 1, wherein the ball scooping part scoops up the balls rolling between the ball thread grooves in a direction of tangent to a center of centroid circle of the balls, to thereby guide the balls to the ball return path.

13. The ball screw according to claim 1, wherein the ball scooping part is located at a phase angle smaller than 90°.

14. The ball screw according to claim 1, wherein a pair of side-cap-constituting parts constituting the side cap respectively includes a groove part, the ball return path is formed by coupling the groove parts with each other, and a boundary between the surfaces of the side-cap-constituting members to be coupled is chamfered, tilted or curved so as to prevent forming a step.

15. The ball screw according to claim 1, wherein the surfaces of the side-cap-constituting members to be coupled each other are curved so as to prevent forming a step in the ball return path.

16. The ball screw according to claim 1, wherein the side cap comprises a pair of columnar ball scooping parts to be fitted into ball circulation holes formed in the side cap mount surface; a plate side cap main body having a ball return path connected with a ball return guide path formed in the columnar ball scooping part; and the columnar ball scooping part is formed a circular form in a cross part.

17. The ball screw according to claim 16, wherein the ball return guide path has an inner diameter of about 1.01 to 1.3 times with respect to a diameter of the ball, and is formed in the ball scooping part in such a manner that a centerline of the ball return guide path is inclined toward a direction of tangent to a center of centroid circle of the balls rolling between the ball thread grooves.

18. The ball screw according to claim 17, wherein the ball return guide path is formed in the ball scooping part in such a manner that the center line of the ball return guide path is located within the centroid circle of the balls at a boundary between the ball return guide path and a ball loaded rolling groove formed between the ball thread grooves.

19. A ball screw comprising:
a screw shaft including a ball thread groove formed on an outer peripheral surface thereof;
a nut including a ball thread groove formed on an inner peripheral surface thereof, the ball thread groove being opposed to the outer peripheral surface of the screw shaft;
a plurality of balls rolling a ball loaded rolling groove disposed between the thread groove of the screw shaft and the thread groove of the nut consequently with a rolling movement of the screw shaft or the nut; and
a ball circulation member for circulating the balls at an outside of the nut, including two ball scooping parts fitted into a ball scooping hole and a ball return hole, respectively, both holes being opened in the outer periphery of the nut, one ball scooping part and the other ball scooping part being linked together,
wherein a center axis line of the ball return path formed in the each two ball scooping parts is free from in parallel with peripheral surfaces of the ball scooping parts.

20. The ball screw according to claim 19, wherein the ball return path is divided by two circulation-part-constituting members constituting the ball circulation member, along a direction of the ball rolling.

21. The ball screw according to claim 20, wherein the circulation-part-constituting members each have mating surfaces, and groove parts forming the ball return path are formed in the respective mating surfaces.

22. The ball screw according to claim 20, wherein the circulation-part-constituting members are formed from resin by injection molding.

23. The ball screw according to claim 20, wherein the circulation-part-constituting members are formed from metal by injection molding or sintering.

24. The ball screw according to claim 1, wherein a direction in which the balls are scooped up by the ball scooping parts forms an angular difference of 15° or less with respect to a helical direction of the ball thread grooves.

25. The ball screw according to claim 19, wherein the ball circulation member is formed from a tubular member, and the ball scooping parts is formed by buildup welding of both ends of the tubular member.

26. A ball screw comprising:
a screw shaft including a helical thread groove formed on an outer peripheral surface thereof;
a nut including a thread groove formed on an inner peripheral surface thereof and corresponding to the thread groove of the screw shaft and fitted to the screw shaft;
a plurality of balls rotatably loaded into a loaded rolling groove defined between the thread grooves;
a side cap attached to an outer peripheral part of a nut and having a ball circulation path for scooping up the balls rolling along the loaded rolling groove in a direction matching lead angles of the thread grooves and returning the balls to the loaded rolling groove; and
a sound insulation member provided so as to cover the side cap.

27. The ball screw according to claim 26, wherein a sound absorbing member is interposed between the side cap and the sound insulation member.

28. A ball screw comprising:
a screw shaft including a helical thread groove formed on an outer peripheral surface thereof;
a nut including a thread groove formed on an inner peripheral surface thereof and corresponding to the thread groove of the screw shaft and fitted to the screw shaft;
a plurality of balls rotatably loaded into a loaded rolling groove defined between the thread grooves;
a side cap attached to an outer peripheral part of a nut and having a ball circulation path for scooping up the balls rolling along the loaded rolling groove in a direction matching lead angles of the thread grooves and returning the balls to the loaded rolling groove; and
a sound insulation member provided in the side cap by insert molding.
